(19) United States
(12) Patent Application Publication
(10) Pub. No.: US 2025/0091714 A1
(43) Pub. Date: Mar. 20, 2025

(54) AUTOMATIC GRASPER ALIGNMENT SYSTEM FOR AN UNMANNED VEHICLE

(71) Applicant: DroneUp, LLC, Virginia Beach, VA (US)

(72) Inventors: Christopher J. BLOWER, El Cerrito, CA (US); Courtney L. PERSON, San Francisco, CA (US)

(21) Appl. No.: 18/441,875

(22) Filed: Feb. 14, 2024

Related U.S. Application Data
(60) Provisional application No. 63/539,059, filed on Sep. 18, 2023.

(51) Int. Cl. B64D 1/10; B64U 20/00; B64U 101/67

(52) U.S. Cl. CPC B64D 1/10; B64U 20/00; B64U 2101/67

(57) ABSTRACT

An apparatus according to an embodiment includes a receptacle configured to be coupled to an aerial vehicle, a winch configured to be coupled to the receptacle and the aerial vehicle, and a grasper having a multi-bar linkage. The grasper is configured to be coupled to the winch by a tether. The multi-bar linkage of the grasper is configured to be releasably coupled to a package. The grasper is configured to be rotated to a predefined alignment as the winch raises the grasper and the grasper contacts the receptacle.

### CROSS-REFERENCE TO RELATED APPLICATIONS

This application claims priority to U.S. provisional patent application No. 63/539,059, filed Sep. 18, 2023 and titled “APPARATUS, SYSTEMS, AND METHODS TO GRASP AND RELEASE PACKAGES AT AN UNMANNED AERIAL VEHICLE, the contents of which are incorporated by reference herein in its entirety.

This application is related to U.S. non-provisional patent application No. [Attorney Docket No.: DRUP-013/00US 334412-2036], filed concurrently herewith, and U.S. non-provisional patent application No. [Attorney Docket No.: DRUP-014/00US 334412-2037], filed concurrently herewith, the contents of each of which are incorporated by reference herein in its entirety.

### FIELD

One or more embodiments are related to apparatus, systems, and methods to grasp, release, and/or orient packages at an unmanned aerial vehicle.

### BACKGROUND

Drones can sometimes be used to pick up and deliver packages. As such, it can be desirable in at least some situations to have apparatus configured to grasp and release packages by a drone, particularly without electronic actuators, to selectively release packages from the drone from the air or directly to a landing surface, and to rotate a grasper to a predefined alignment relative to a drone, such as when the grasper is not in use.

### SUMMARY

An apparatus according to an embodiment includes a receptacle configured to be coupled to an aerial vehicle, a winch configured to be coupled to the receptacle and the aerial vehicle, and a grasper having a multi-bar linkage. The grasper is configured to be coupled to the winch by a tether. The multi-bar linkage of the grasper is configured to be releasably coupled to a package. The grasper is configured to be rotated to a predefined alignment as the winch raises the grasper and the grasper contacts the receptacle.

### BRIEF DESCRIPTION OF THE DRAWINGS

FIG. 1 shows a perspective view of a grasper apparatus to grasp and release a package, according to an embodiment, including a grasper shown in an open configuration.

FIG. 2 shows a side view of the grasper of the apparatus of FIG. 1 in a closed configuration, with a portion of the grasper shown in transparency for the sake of illustration.

FIG. 3 shows a perspective view of a multi-bar linkage of the apparatus of FIG. 1.

FIG. 4 shows another perspective view of the multi-bar linkage of FIG. 3 of the apparatus of FIG. 1.

FIG. 5 shows a perspective view of a selectively actuatable hook to aerially release a package coupled to the grasper apparatus of FIG. 1, according to an embodiment.

FIG. 6 shows a bottom perspective view of the apparatus of FIG. 5 coupled to a winch configured for use with an aerial vehicle.

FIG. 7 shows a perspective view of an apparatus that includes the grasper of FIG. 1 and a receptacle, according to an embodiment, with the receptacle of the apparatus shown in transparency for the sake of illustration.

FIG. 8 shows a cross-sectional perspective view of the receptacle and a grasper, of the apparatus of FIG. 7.

FIG. 9 shows a cross-sectional side view of the receptacle of the apparatus of FIG. 7.

FIG. 10 shows a perspective view of a portion of a winch that includes a guide pulley and a load cell, according to an embodiment.

FIG. 11 shows a side view of the guide pulley and the load cell, of the apparatus of FIG. 10.

FIG. 12 shows a bottom view of the grasper of FIG. 1.

FIG. 13 shows a perspective view of the grasper of FIG. 1.

FIG. 14 shows an end view of a portion of the apparatus of FIG. 7 that includes the receptacle.

FIG. 15 shows a perspective view of the grasper of the apparatus of FIG. 7 in an open configuration and magnetically coupled to the receptacle.

FIG. 16 shows a perspective view of the grasper of FIG. 1 in a closed configuration.

FIG. 17 shows a side view of the grasper of FIG. 1 in a closed configuration.

FIG. 18 shows a top perspective view of the grasper of FIG. 1 in a closed configuration.

FIG. 19 shows a perspective view of a portion of the receptacle of the apparatus of FIG. 7 that includes guide protrusions, with a portion of the receptacle removed for the sake of illustration.

FIG. 20 shows a cross-sectional side view of the receptacle of the apparatus of FIG. 7.

FIG. 21 shows a cross-sectional side view of the grasper of FIG. 1 including a spring seat, according to an embodiment.

FIG. 22 shows a perspective view of the grasper of FIG. 21 and a torsion spring.

FIG. 23 shows a bottom view of the grasper of FIG. 22 in an open configuration.

FIG. 24 shows a bottom perspective view of the grasper of FIG. 22, with a portion of the grasper removed for the sake of illustration, in an open configuration.

FIG. 25 shows a side perspective view of the grasper of FIG. 22 in an open configuration.

FIG. 26 shows a side perspective view of the grasper of FIG. 22 in a closed configuration.

FIG. 27 shows a side view of a selectively actuatable flight lock included in the apparatus of FIG. 5 and releasably coupled to a package.

FIG. 28 shows a side view of a selectively actuatable flight lock included in the apparatus of FIG. 5 and selectively uncoupled from a package.

FIG. 29 shows a perspective side view of the selectively actuatable flight lock of FIG. 27.

FIG. 30 shows a perspective view of the selectively actuatable flight lock of FIG. 27 releasably coupled to a package.

### DETAILED DESCRIPTION

Some implementations are related to an apparatus configured for package pick-up and delivery by a drone (or aerial vehicle). The apparatus can be releasably coupled to a package such that a drone can lift a package from a surface, hold a package during transport, and/or release a package to a delivery location. The surface and/or delivery location can include, for example, a container (or, more particularly, a landing pad of a container) as described in U.S. provisional patent application No. 63/467,854, filed May 19, 2023 and titled “Systems and Methods to Store and Retrieve Packages from a Container that Includes a Polar Axial Robot” and U.S. provisional patent application No. 63/539,074, filed Sep. 18, 2023 and titled “Systems and Methods to Store and Retrieve Packages from a Container that Includes a Polar Axial Robot,” the contents of each of which are incorporated herein by reference in its entirety. In one example, a drone or aerial vehicle refers to an autonomous vehicle. In another example, a drone or aerial vehicle refers to a vehicle that can be remotely piloted. Although the below description will mostly be discussed in the context of drones or aerial vehicles, it can be appreciated that the drone can be any other type of vehicle, such as an aerial vehicle different than a drone, a ground vehicle, a water vehicle, and/or the like. Examples of a drone can include an unmanned aerial vehicle, a quadcopter, an unmanned rotorcraft, an unmanned rotary-wing aircraft, a blimp, a remote-controlled aircraft, a multirotor aircraft, or any other unmanned vehicle suitable for aerial delivery of one or more packages.

In some embodiments, the system can release a package after the package has contacted a landing surface, and/or selectively release a package a non-zero distance above a landing surface. Said differently, the apparatus can be used to selectively (1) release a package from a drone while the package is still airborne and (2) release the package after the package has contacted a landing surface. In some implementations, the system can comprise a grasper configured to be rotated to one or more predefined alignments while a winch configured to be coupled to the drone raises the grasper toward a receptacle.

### Drone Grasp and Release Apparatus

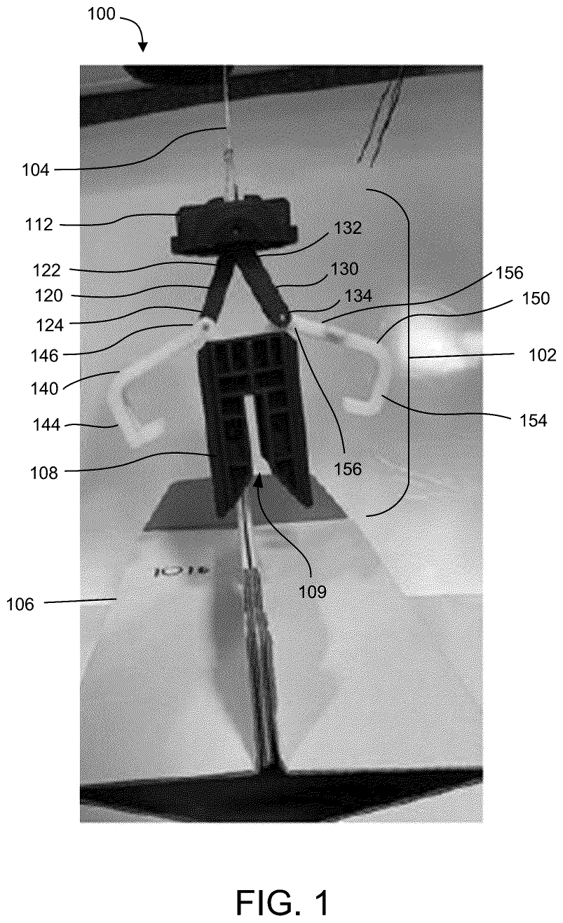

An apparatus 100 according to an embodiment is shown in FIGS. 1-4. The apparatus 100 is configured to grasp a package 106 for transport (e.g., by a drone, aerial vehicle or other suitable vehicle as described herein) from one location to another and to release the package. The apparatus 100 includes a grasper 102. The apparatus 100, or the grasper 102 specifically, can be configured to grasp the package automatically in response the grasper 102 being moved into contact with the package, and/or configured to release the package automatically in response to the package being placed on a landing surface, as described in more detail herein. In this manner, in some implementations, the grasper 102 can passively grasp and/or release the package, for example, without any electronic actuation.

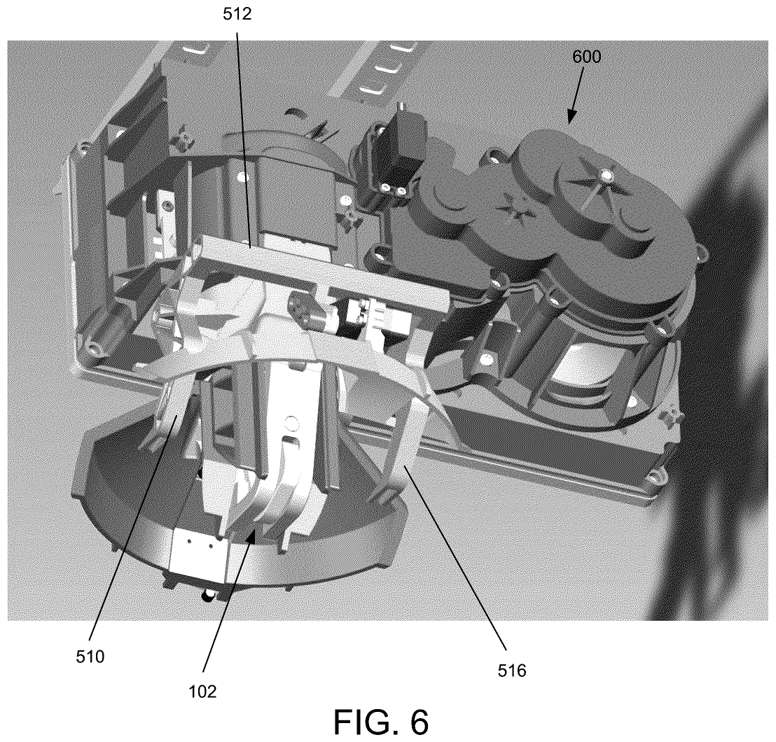

In some implementations, the apparatus 100 includes a tether 104 having a first end coupled to the grasper 102 and a second end coupled to a winch (e.g., winch 600, shown in FIG. 6) coupled to a drone (not shown). The winch is configured to retrieve the tether 104 to move grasper 102 toward the drone and to pay out the tether 104 to move grasper 102 away from the drone. The winch is further configured to change a tension force applied to tether 104, causing tether 104 to be in one of slack or tension modes. The tether 104 can include a rope, cable, leash, chain, strap, cord, string, line, belt, and/or any other restraint suitable for operably coupling to a winch (e.g., winch 600 of FIG. 6), or a combination thereof.

The grasper 102 includes a first member 108 that can be configured to receive at least part of the package 106. For example, the first member 108 can define a slot 109, which can receive a portion, such as a handle portion, of the package 106. A portion (e.g., distal end portion) of the first member 108 that defines the slot 109 can be sloped or angled, to help direct the portion of the package 106 into the slot 109. The package 106 can be, for example, a container within which one or more items and/or goods to be shipped, delivered, and/or otherwise transported by drone are disposed. The package 106 can be constructed from any suitable material or combination of materials, including, for example, cardboard, plastic, wood, metal, or any other flexible or rigid material suitable for containing one or more items and/or goods to be shipped, delivered, and/or otherwise transported by drone. The package 106 can define one or more openings used to releasably couple package 106 to grasper 102. In some implementations, although not shown in FIG. 1, package 106 can comprise one or more extensions, extrusions, hooks, right angles, or any other features configured to be used to operably and releasably couple package 106 to grasper 102. In some implementations, the one or more openings are integrated into one or more carry handles of package 106.

The grasper 102 also includes a second member 112 configured to be coupled to a tether. More specifically, the tether 104 can be coupled to or otherwise extend from a top side of the second member 112. The second member 112 can be coupled to the first member via a multi-bar linkage of the grasper 102.

The multi-bar linkage can include a first link 120, a second link 130, a third link 140, and a fourth link 150. The multi-bar linkage can also include at least four pivot joints. The first link 120 includes a first end portion 122 and a second end portion 124 that is opposite first end portion 122 of the first link 120. The second link comprises a first end portion 132 and a second end portion 134 that is opposite the first end portion 132 of the second link 130.

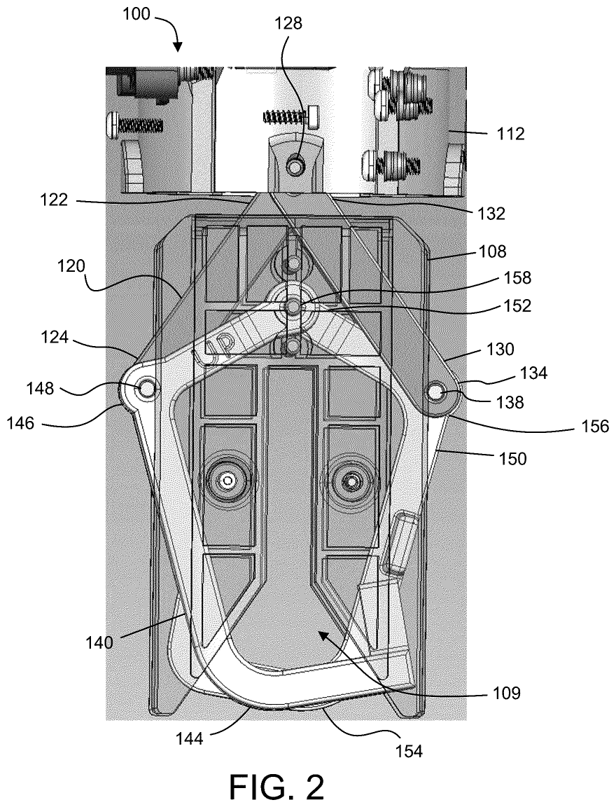

The first end portion 122 of the first link 120 and the first end portion 132 of the second link 130 are each pivotably coupled to the second member 112 (e.g., substantially opposite the top side of second member 112). In some implementations, the first end portion 122 of the first link 120 is pivotably coupled to the first end portion 132 of the second link 130, and both the first end portions 122, 132 of the first and second links 120, 130, respectively, are pivotably coupled to second member 112 (e.g., at a pivot joint 128, shown in FIG. 2).

The third link 140 includes a proximal end portion 142, a distal end portion 144, and an intermediate portion 146 disposed between the distal end portion 144 of the third link 140 and the proximal end portion 142 of the third link 140. The proximal end portion 142 of the third link 140 is pivotably coupled to the first member 108 (e.g., at a pivot joint 158, as shown in FIG. 2). The intermediate portion 146 of the third link 140 is pivotably coupled to the second end portion 124 of the first link 120 (e.g., at a pivot joint 148).

The fourth link 150 includes a proximal end portion 152, a distal end portion 154, and an intermediate portion 156 disposed between the distal end portion 154 of the fourth link 150 and the proximal end portion 152 of the fourth link 150. The proximal end portion 152 of the fourth link 150 is pivotably coupled to the first member 108 (e.g., at the same pivot joint 158 at which the proximal end portion 142 of the third link 140 is coupled to the first member 108). In some implementations, the first member 108 is coupled to the pivot joint 158 between the third link 140 and the fourth link 150. The intermediate portion 156 of the fourth link 150 is pivotably coupled to the second end portion 134 of the second link 130 (e.g., at a pivot joint 138). The first member 108 is shown transparent in FIG. 2 for the sake of more readily showing the links 120, 130, 140, 150 and pivot joints 128, 138, 148 158.

The distal end portions 144, 154 of each of the third link 140 and the fourth link 150, respectively, are configured to interface with a package on a first side of the package 106 and a second side of the package 106, respectively. At least a portion of the third link 140 and the fourth link 150 are configured to have substantial “J” shape defined, at least in part, by the respective distal end portions of the third link and the fourth link. In some implementations, the distal end portion 144, 155 of the third link 140 or the fourth link 150, respectively, can include a bend so that a centerline of the distal end portion 144, 154 of the link 140, 150 to one side of the bend is non-linear with, and in some implementations substantially orthogonal to, a centerline of the distal end portion 144, 154 of the link 140, 150 to the other side of the bend (and that is in contact with the intermediate portion 146, 156 of the link 140, 150). As such, the distal end portion 144 of the third link 140 to the one side of the bend can be configured to interface with and/or contact the first side of the package 106 (e.g., a first side of a handle of the package) when the third link 140 is coupled to the package, and the distal end portion 154 of the fourth link 150 to one side of the bend can be configured to interface with and/or contact the second side of the package 106 (e.g., a second side of a handle of the package) when the fourth link 150 is coupled to the package, as described herein. In some implementations, the fourth link 150 can have a side profile shape that is substantially the same as or a mirror image of a side profile shape of the third link 140.

The third link 140 and fourth link 150 collectively have at least a closed configuration (see, e.g., FIGS. 2-4) and an open configuration (see, e.g., FIG. 1). The third and fourth links 140, 150 can have additional configurations that are between the closed configuration and the open configuration and/or that extend beyond the closed configuration and the open configuration. When the third link 140 and the fourth link 150 collectively are in the closed configuration and engaged with the package 106, at least a portion of the distal end portion 144 of the third link 140 and at least a portion of the distal end portion 154 of the fourth link 150 are disposed within one or more openings of the package 106. As such, the grasper 102 is or can be releasably coupled to package 106.

In some implementations, the multi-bar linkage 110 includes a first portion and a second portion, and the first portion of the multi-bar linkage is disposed on the first side of the package while grasper 102 is releasably coupled to the package and the second portion of the multi-bar linkage being disposed on a second side of the package while grasper 102 is releasably coupled to the package. When the third link 140 and the fourth link 150 collectively are in the open configuration, the third link 140 and fourth link 150 are substantially outside the one or more openings of package 106. As such, grasper 102 is uncoupled from package 106.

The first member 108 is configured to be substantially weighted such that the first member 108 causes a tension force to be applied to tether 104 when tether 104 is used to suspend the grasper 102. In some implementations, the grasper 102 has a bias toward the open configuration, such as when the first member 108 applies the tension force to tether 104 and grasper 102 is not engaged with the package 106. When the grasper 102 is in the open configuration, the third link 140 and fourth link 150 (e.g., the distal end portions 144, 154, respectively, thereof) are substantially apart from each other.

First member 108 is configured to contact and/or be disposed on package 106 while a portion of package 106 is received within slot 109. When the first member 108 is disposed on package 106 and grasper 102 does not apply a tension force on tether 104 or applies a tension force that is substantially reduced (e.g., because the tether is paid out when the grasper 102 is disposed on the package that is disposed on a landing surface), grasper 102 is configured to be in the open configuration. In some in some implementations, while grasper 102 is in the closed configuration, at least a portion of the distal end portion 144 of the third link 140 and the distal end portion 154 of the fourth link 150 are disposed within slot 109 of first member 108.

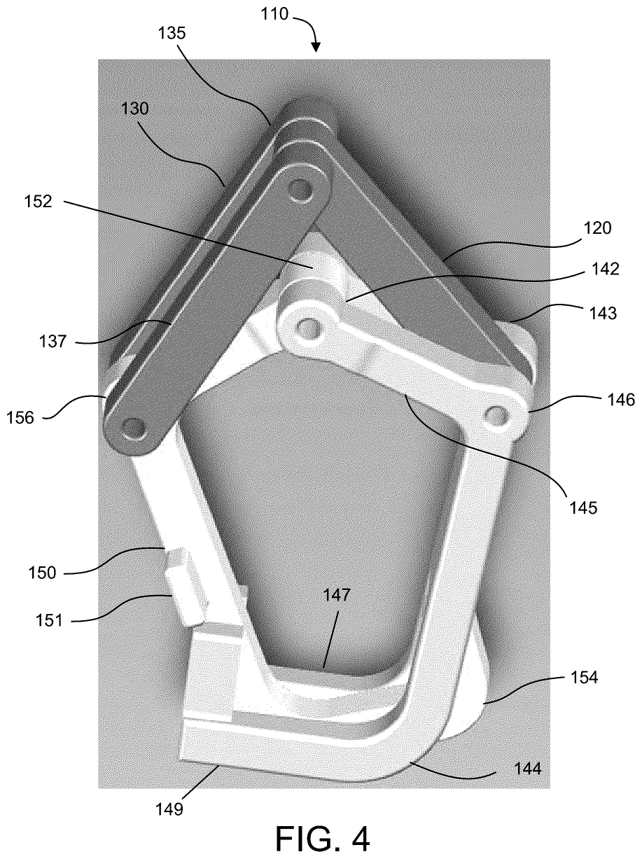

As shown in FIG. 4, in some implementations, the proximal end portion 142 of third link 140 can include a first elongate portion 143 and a second elongate portion 145 separated from first elongate portion 143 by a non-zero distance sized to permit the at least a portion of the distal end portion 124 of the first link 120 to be disposed between at least a portion of each of the first and second elongate portions 143, 145 of the third link 140 when the grasper 102 is in the closed configuration. The first elongate portion 143 and second elongate portion 145 of the proximal end portion 142 of the third link 140 can be approximately parallel to each other.

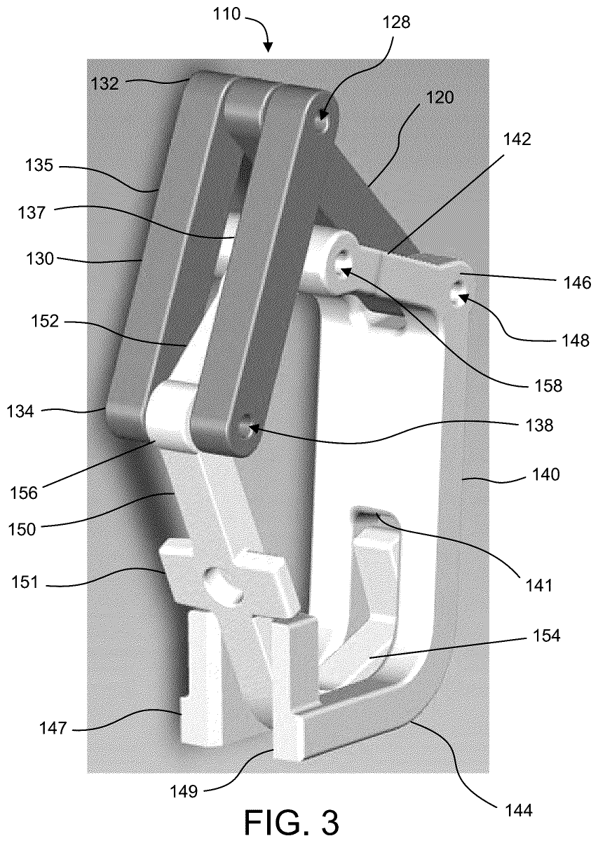

As shown in FIGS. 3-4, in some implementations, the distal end portion 144 of third link 140 can include a first elongate portion 147 and a second elongate portion 149 separated from first elongate portion 147 by a non-zero distance sized to permit the at least a portion of the distal end portion 154 of the fourth link 150 to be disposed between at least a portion of each of the first and second elongate portions 147, 149 of the third link 140 when the grasper 102 is in the closed configuration. The distal end portion 144 of the third link 140, including the first elongate portion 145 and second elongate portion 149, can be substantially J-shaped (e.g., from a side profile view; see, e.g., FIG. 4). In other implementations, the distal end portion 144 of the third link 150 (optionally including, for example, the first elongate portion 147 and second elongate portion 149) can be substantially L-shaped, C-shaped, U-shaped, or any suitable other shape (e.g., from a side profile view) such that the multi-bar linkage 110 encloses a portion of the package 106. The first elongate portion 147 and second elongate portion 149 of the distal end portion 144 of the third link 140 can be approximately parallel to each other.

To load or releasably couple the package 106 to the grasper 102 and move the grasper from the open configuration to the closed configuration, at least a portion of package 106 is moved into the slot 109 defined by the first member 108. In some implementations, the grasper 102 is lowered to the package from above via the tether until the first member 108 contacts the package 106 and/or at least a portion of the package is moved into the slot 109. In some implementations, the package 106 can be alternatively or additionally raised into the slot 109 by a human operator, actuated machine, hydraulic or motorized lift, robotic arm, or any other suitable lift mechanism.

The package 106 can be moved into the slot 109 such that first member 108 is disposed on package 106. Then, a tension force applied to tether 104 is prevented or substantially reduced (i.e., tether 104 is in a slack state), for example by paying out the tether 104 via the winch. In response, a linear distance between the second member 112 and the first member 108 is reduced, which pivots the first and second links 120, 130 about pivot joint (or connection) 128 and moves their respective distal end portions 124, 134 away from each other, thereby increasing an internal angle therebetween. Then, as package 106 is moved or raised into slot 109, the proximal end portion 142 of the third link 140 and the proximal end portion 152 of the fourth link 150 move or rotate upward relative to the first link 120 and the second link 130, respectively, which moves distal end portions 144, 154 of the third and fourth links 140, 150, respectively, to move towards each other. Thus, as a result of the proximal end portion 152 of the third link 140 and the proximal end portion 152 of the fourth link 150 moving upward, grasper 102 transitions from the open configuration to the closed configuration.

As shown in FIG. 3, in some implementations, at least one of the third link 140 and the fourth link 150 can be configured to help limit the rotational range of motion of the other of the third link 140 or fourth link 150 in the direction of movement towards the closed configuration. For example, as shown in FIG. 3, the fourth link 150 can include one or more protrusions 151 that extend outwardly from a centerline of the fourth link 150, which provide one or more shoulders against which a distal end face of the distal end portion 144 (e.g., of one or more of the elongate portions 147, 149) of the third link 140 can abut or otherwise contact during rotational movement to the closed configuration. The third link 140 can include a surface 141 extended between the first elongate portion 147 and the second elongate portion 149 of the third link 140 that is configured to contact a distal end face of the distal end portion 154 of the fourth link 150 during rotational movement to the closed position.

In some implementations, a first angle between a portion of the first link 120 and a portion of the third link 140 and a second angle between a portion of the second link 130 and a portion of the fourth link 150 will each decrease in value as grasper 102 transitions from the open configuration to the closed configuration. When grasper 102 moves to the closed configuration, the slot 109 receives at least a portion of the distal end portion 144 of the third link 140 and the distal end portion 154 of the fourth link 150. In some implementations, the package 106 remains on the surface while grasper 102 is releasably coupled to package 106. In some implementations, package 106 is releasably coupled to grasper 102 at a first location different from a second location where grasper 102 is to release the package 106.

When the grasper 102 is in the closed configuration, the tether 104 can be tensioned such that grasper 102 is maintained in the closed configuration. Said another way, when the grasper 102 is in the closed configuration, the tether 104 can be tensioned such that grasper 102 is prevented from moving from the closed configuration to the open configuration. When the tether 104 is tensioned, the distal end portion 144 of the third link 140 and the distal end portion 154 of the fourth link 150 are substantially prevented from lowering relative to the first link 120 and the second link 130, maintaining grasper 102 in the closed configuration.

In some implementations, the tether 104 can be tensioned using a winch (e.g., winch 600 of FIG. 6) coupled to a drone, whereby the winch is configured to retrieve the tether 104 from a portion of the tether 104 substantially opposite to an end of the tether 104 coupled to the grasper 102. In some implementations, tether 104 can be tensioned by a drone controlled to move in a manner that increases the distance between the drone and the grasper, thereby removing any slack in tether 104 and applying a tension force to tether 104. In some implementations, tether 104 can be tensioned by resting package 106 on at least one of the distal end portion 144 of the third link 140 and the distal end portion 154 of the fourth link 150, thereby causing first member 108 to be spaced apart from the package 106.

To release the package 106 from the grasper 102, the grasper is moved from the closed configuration to the open configuration. The grasper 102 can be configured to release package 106 after package 106 has contacted a landing surface (e.g., the ground, a landing pad, a shelf, a rooftop, or other suitable landing surface). The drone coupled to the tether 104 can controllably descend from a higher altitude to a lower altitude to cause package the 106 to contact the landing surface to deliver of the package. The winch (e.g., winch 600 of FIG. 6) can be configured to pay out tether 104 to move grasper 102 and package 106 away from the drone, causing package 106 to contact the landing surface.

After package 106 is disposed on the landing surface, the tension force applied to tether 104 can be removed or substantially reduced, i.e., tether 104 is slackened. For example, the tension force can be reduced by controllably descending the drone from a higher altitude to a lower altitude, thereby decreasing the distance between the drone and package 106 resting on the landing surface and slackening the tether therebetween. In another example, the tension force can be removed or substantially reduced using the winch (e.g., winch 600 of FIG. 6) to pay out the tether 104.

During removal or reduction of the tension force applied to the tether 104 (e.g., whether by descent of the drone towards the package 106 or paying out of the tether 104) when the package 106 is on the landing surface (or coupled to a hook 510, as described in more detail herein), the first member 108 becomes disposed on or rests on the package 106 (e.g., as a result of gravity). As a result of the first member 108 being disposed on or resting on the package 106, the distal end portions 144, 154 of the third and fourth links 140, 150, respectively, can be lowered with respect to the package 106 so that they can each clear a solid portion of the package 106 (e.g., a solid portion of the package above the one or more openings of the package, or, more specifically, of the package handle). After the distal end portions 144, 154 of the third and fourth links 140, 150, respectively, are lowered to clear the solid portion of the package 106, the second member 112 is raised relative to the package 106. The second member 112 can be raised by ascent of the drone coupled to grasper 102 via the tether 104 and/or by retrieval of the tether 104 (e.g., via the winch). As the second member 112 is raised, the first member 108 is lowered relative to the second member 112 (such that a linear distance between the second member 112 and the first member 108 is increased, and, for example, due to the weight of the first member), thereby applying a pulling force on the proximal end portions 142, 152 of the third and fourth links 140, 150 at pivot joint 158. The pulling force at pivot joint 158 caused by the downward movement of first member 108 causes the proximal end portion 142 of the third link 140 and the proximal end portion 152 of the fourth link 150 to move downwards relative to the first link 120 and the second link 130 of the multi-bar linkage and further causes the distal end portion 144 of the third link 140 and the distal end portion 154 of the fourth link 150 to move away from each other. The distal end portion 144 of the third link 140 and the distal end portion 154 of the fourth link 150 having moved sufficiently far away from each other causes grasper 102 to be in the open configuration. When grasper 102 is in the open configuration, the distal end portion 144 of the third link 140 and the distal end portion 154 of the fourth link 150 are no longer disposed within the one or more openings of package 106. As a result of the distal end portions 144, 154 of the third and fourth links 140, 150, respectively, being disposed substantially outside of the one or more openings of package 106 while grasper 102 is in the open configuration, the package 106 is released from the grasper 102. In some implementations, the package 106 is released at a second location different from the first location where package 106 was releasably coupled to grasper 102.

In some implementations, to further separate the first member 108 from the package 106 while grasper 102 is in the open configuration, the drone can be controlled to ascend from a lower altitude to a higher altitude, thereby raising the grasper 102 via the tether 104 away from the package 106, and/or the winch (e.g., winch 600 of FIG. 6) can retrieve the tether 104 to move grasper 102 away from package 106.

As discussed above, the multi-bar linkage 110 includes a plurality of pivotably coupled links. The proximal (or first) end portion 122 of first link 120 and the proximal (or first) end portion 132 of second link 130 are each pivotably coupled to the second member 112. The distal (or second) end portion 124 of the first link 120 is pivotably coupled to the intermediate portion 146 of third link 140, and the distal (or second) end portion of the second link 130 is pivotably coupled to the intermediate portion 156 of the fourth link 150. The proximal (or first) end portion 142 of the third link 140 and the distal (or second) end portion 154 of the fourth link 150 are each pivotably coupled to first member 108. Thus, in some implementations, the multi-bar linkage 110 can include a four-bar linkage. In some implementations, as shown in FIGS. 3-4, the second link 130 of the multi-bar linkage can optionally include a first elongate member 135 and a second elongate member 137 spaced apart from the first elongate member 135 by a non-zero distance sized to permit the proximal end portion 122 of the first link 120 to be disposed between the elongate members 135, 137 of the second link 130 and to permit the intermediate portion 156 of the fourth link 150 (and a portion of the proximal end portion 152 of the fourth link 150) to be disposed between the elongate members 135, 137 of the second link 130. The elongate members 135, 137 of the second link 130 are each pivotably coupled at the proximal end portion 132 of the second link 130 to the second member 112 (e.g., a pivot joint 128) and are pivotably coupled at the distal end portion 134 of the second link 130 to the intermediate portion 156 of fourth link 150 (e.g., at pivot joint 138).

Multi-bar linkage 110 can further comprise a plurality of pivot or revolute joints (i.e., hinge joints or pin joints) configured to pivotably couple one or more links to one or more other links. In some implementations, multi-bar linkage 110 includes one or more link pairs, the relative motion of the first link of the link pair and the second link of the link pair being constrained to rotation along a common axis.

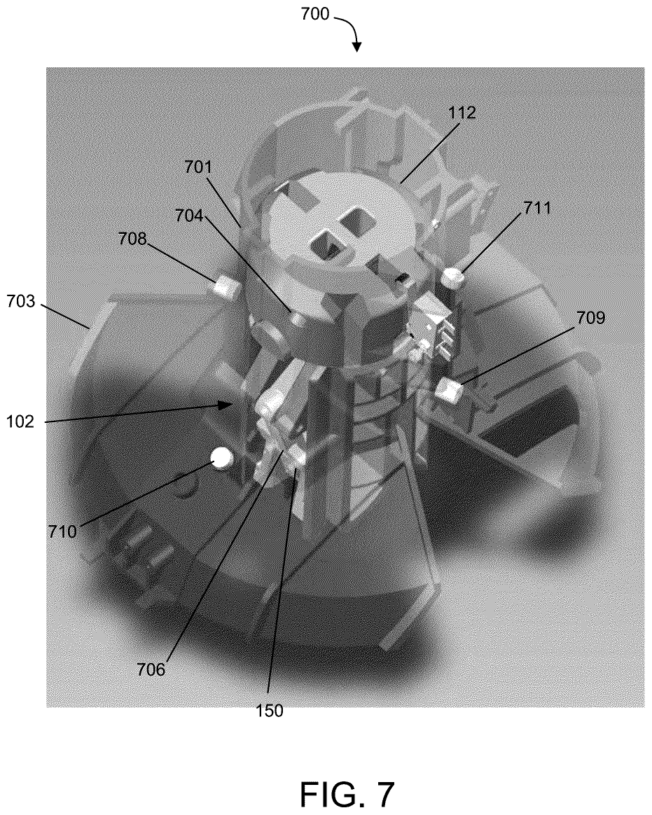

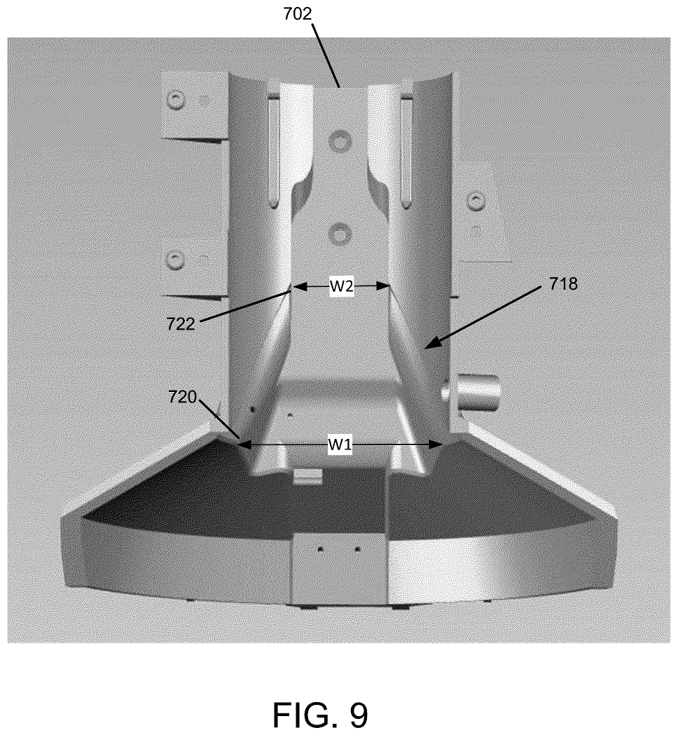

In some implementations, a receptacle 702 (see, e.g., FIGS. 7-9) is configured to be coupled to an aerial drone having a winch (e.g., winch 600) that is configured to retrieve the tether 104 to move the grasper 102 and the package 106 towards the aerial drone and to pay out the tether 104 to move the grasper 102 and the package 106 away from the aerial drone. The receptacle 702 can be configured to receive at least a portion of the grasper 102. At least a portion of the receptacle 702 can have a generally conical shape. The receptacle 702 can include an interior surface that narrows from a lower portion of the receptacle 702 to an upper portion of the receptacle 702. The tether 104 is disposed within an opening of the receptacle 702. In some implementations, this opening is disposed at or proximal to the center of the receptacle 702. The tether 104 is configured to slidably translate with respect to the receptacle 702. The receptacle 702 and the grasper 102 are arranged such that at least a portion of the receptacle 702 is positioned above at least a portion of the second member 112. The receptacle 702 is configured to at least partially receive at least one of the second member 112, the first link 120, the second link 130, the third link 140, the fourth link 150, or the first member 108 of the grasper 102. The grasper 102 can be in the closed configuration when the grasper 102 is at least partially raised into the receptacle 702 as a result of, for example, the winch retrieving the tether 104. In some implementations, the receptacle 702 is sufficiently rigid to overcome the bias of the multi-bar linkage 110 towards the open configuration. As a result of the grasper 102 being raised with respect to the receptacle 702, the third link 140 and the fourth link 150 can contact a lower or interior surface of the receptacle 702, which can be configured to narrow from a lower portion of the interior surface to an upper portion of the interior surface as described in more detail herein with respect to FIG. 9. As such, the receptacle 702 can cause the third link 140 and the fourth link 150 to each pivot around the pivot joint 158 and further cause the distal end portion 144 of the third link 140 and the distal end portion 154 of the fourth link 150 to move towards each other. When the distal end portion 144 of the third link 140 and the distal end portion 154 of the fourth link 150 move towards each other, the distance between the second member 112 and the first member 108 is reduced as a result of the proximal end portion 142 of the third link 140 and the proximal end portion 152 of the fourth link 150 moving upwards relative to the first link 120 and the second link 130. When the grasper 102 has been raised sufficiently with respect to the receptacle 702, the grasper 102 moves to the closed configuration.

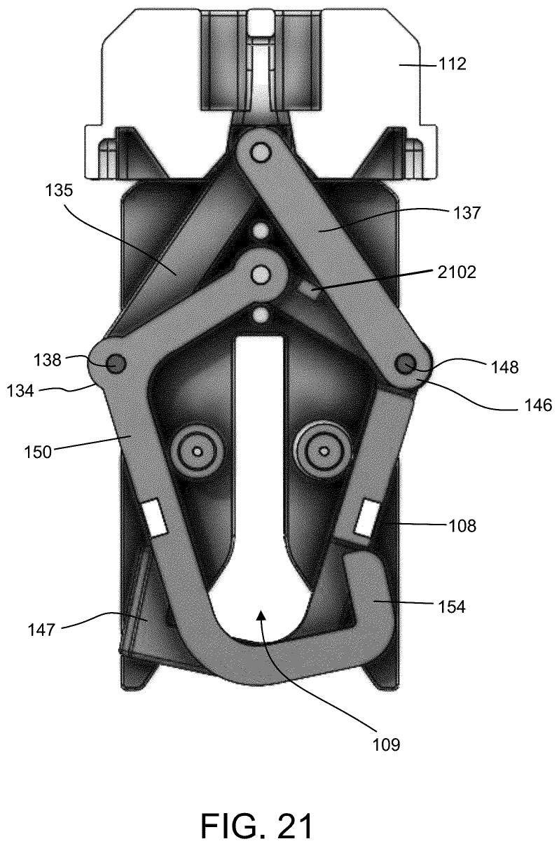

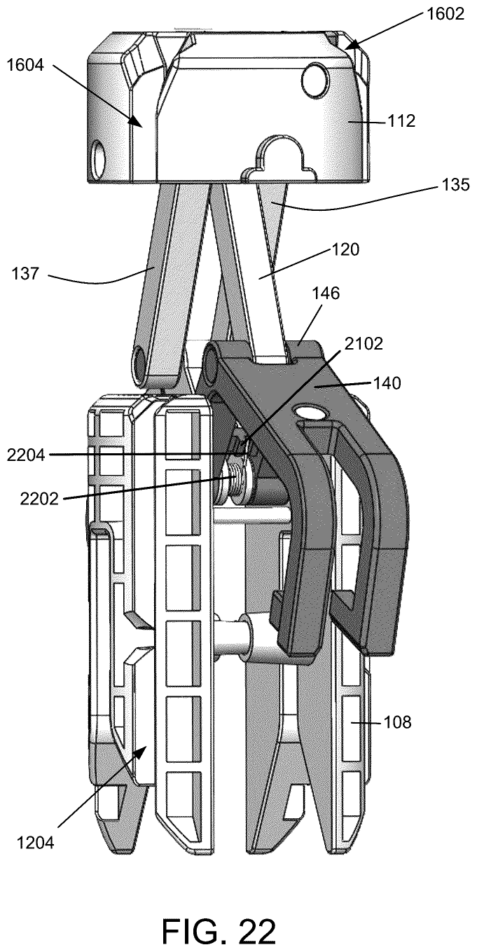

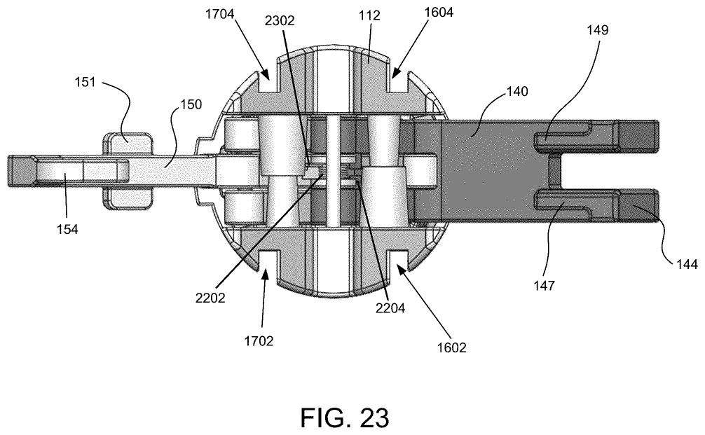

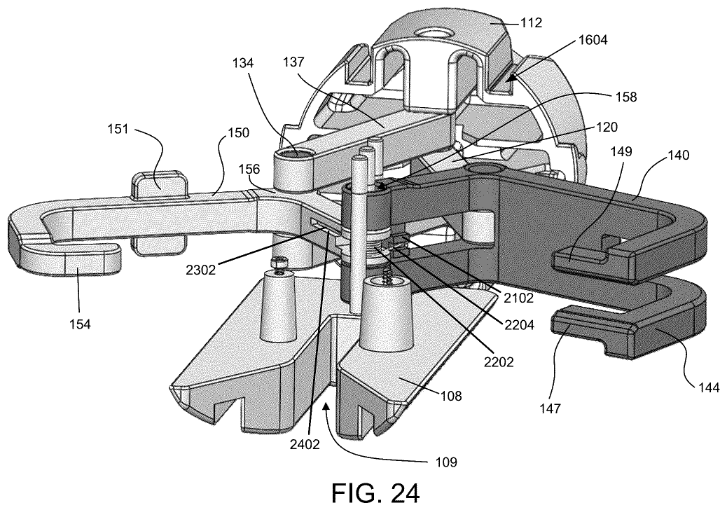

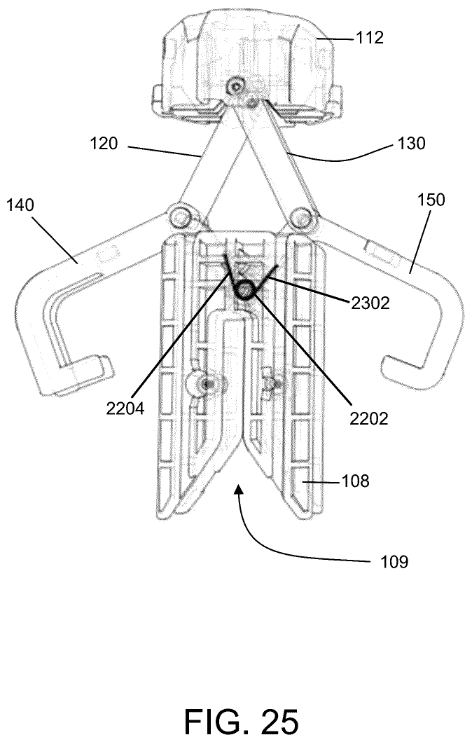

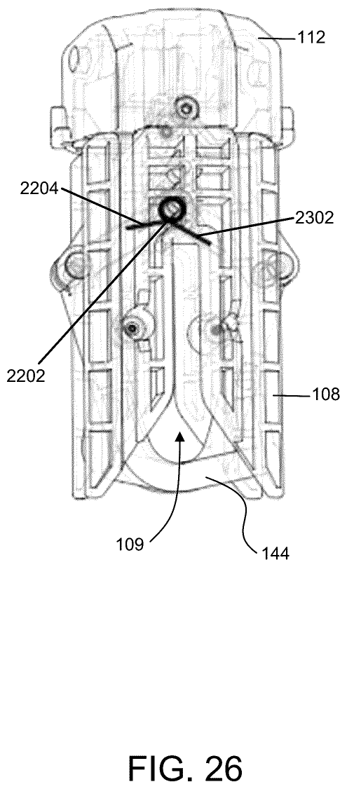

In some embodiments, the grasper 102 can include a spring, such as a torsion spring 2202 (see, e.g., FIGS. 22-26). The torsion spring 2202 can be, for example, a helical torsion spring that includes a plurality of coils piled/stacked relative to each other. Each coil from the plurality of coils can be concentric to the pivot joint 158 (e.g., the plurality of coils can be coaxial to the pivot joint 158). The torsion spring 2202 can also include a first end portion 2204 (see, e.g., FIGS. 22-26) and a second end portion 2302 (see, e.g., FIGS. 23-26). The first end portion 2204 can be coupled to and/or in contact with the third link 140 (e.g., at the proximal end portion 142), and the second end portion 2302 can be coupled to and/or in contact with the fourth link 150 (e.g., at the proximal end portion 152). The first end portion 2204 can include a first elongate section extending from a first terminal coil, and the second end portion 2302 can include a second elongate section extending from a second terminal coil substantially opposite the first terminal coil. In some implementations, the third link 140 can include a spring seat 2102 (see, e.g., FIGS. 21, 22, and 24) configured to interface with the first end portion 2204, and the fourth link 150 can include a spring seat 2402 (see, e.g., FIG. 24) configured to interface with the second end portion 2302.

The torsion spring 2202 can be configured to apply a torque (e.g., a twisting force) as the torsion spring twists along an axis (e.g., as bending moments are applied to the first and second end portions 2204, 2302). The axis can be disposed at or substantially near the center of the plurality of coils and can be coaxial to the pivot joint 158. For example, in some implementations, when the grasper 102 is in a closed configuration, the orientation of the third link 140 and the fourth link 150, respectively, can apply bending moments to the first end portion 2204 and the second end portion 2302, respectively. These bending moments can cause the plurality of coils of the torsion spring 2202 to twist tighter relative to a rest state, causing the torsion spring 2202 to apply a torque that biases the grasper 102 towards an open configuration. When the grasper 102 is in a closed configuration and releasably coupled to a package 106, the distal end portions 144, 154 of the third and fourth links 140, 150, respectively, can be configured to prevent the torque from causing the grasper 102 to move to the closed configuration until the distal end portions 144, 154 of the third and fourth links 140, 150, respectively, have cleared a solid portion of the package 106, as described herein.

During use, and unloading of the package 106 from the grasper 102 particularly, as the grasper 102 moves from a closed configuration to an open configuration, movement of at least one of the first, second, third and/or fourth links 120, 130, 140, 150 causes an inertia that slows an acceleration of descent of the first member 108 under gravitational force, compared to an acceleration of descent of the package under gravitational force. The torsion spring 2202 can be configured to apply, while the grasper 102 moves from a closed configuration to an open configuration, a torque/spring force (e.g., based on a spring constant associated with the torsion spring 2202) that is sufficient to overcome the inertia associated with at least one of the first link 120, the second link 130, the third link 140, and/or the fourth link 150. As a result of the torque/spring force, during unloading of the package 106 from the grasper 102 (e.g., after the package 106 is in contact with a landing surface or the hook 510), the first member 108 and the package 106 can descend (e.g., relative to the second member 112) at an equivalent or substantially equivalent rate of acceleration. As a result of the downward motion of the first member 108, the distal end portions 144, 154 of the third and fourth links 140, 150, respectively, can clear a solid portion of the package 106 (e.g., a solid portion of the package above the one or more openings of the package, or, more specifically, of the package handle and/or gable), resulting in the grasper 102 being in an open configuration and uncoupled from the package 106. Said differently, the torsion spring 2202 can be configured to apply a first force to the grasper 102 that results in a second force (e.g., a gravitational force) applied to the descending (e.g., relative to the second member 112) mass of the first member 108 causing the first member 108 to descend at a substantially equivalent rate of descent, relative to the second member 112, as the package 106. When the grasper 102 is in an open configuration, the torsion spring 2202 can be configured to apply no torque/spring force or a substantially reduced torque/spring force relative to the torque/spring force applied by the torsion spring 2202 when the grasper 102 is in a closed configuration.

In some implementations, the grasper 102 can include a plurality of torsion springs. For example, the grasper 102 can include (1) a first torsion spring having a first end portion in contact with the third link 140 and a second end in contact with the first member 108, and (2) a second torsion spring having a first end portion in contact with the fourth link 150 and a second end in contact with the first member 108.

Although the grasper 102 is described herein as including a torsion spring 2202, in some implementations, the grasper 102 can include any suitable type of spring or other actuator to move and/or bias the third and fourth links as described herein with respect to the torsion spring.

An apparatus according to an embodiment includes a first member, a second member configured to be coupled to a tether, a first link, a second link, a third link, and a fourth link. The first link has a first end portion and a second end portion opposite the first end portion. The first end portion of the first link is pivotably coupled to the second member. The second link has a first end portion and a second end portion opposite the first end portion of the second link. The first end portion of the second link is pivotably coupled to the second member. The third link has a distal end portion, a proximal end portion, and an intermediate portion disposed between the distal end portion of the third link and the proximal end portion of the third link. The distal end portion of the third link is configured to interface with a package on a first side, the proximal end portion of the third link is pivotably coupled to the first member, and the intermediate portion of the third link is pivotably coupled to the second end portion of the first link. The fourth link has a distal end portion, a proximal end portion and an intermediate portion disposed between the distal end portion of the fourth link and the proximal end portion of the fourth link. The distal end portion of the fourth link is configured to interface with a package on a second side opposite the first side, the proximal end portion of the fourth link is pivotably coupled to the first member, and the intermediate portion of the fourth link is pivotably coupled to the second end portion of the second link.

In some implementations, the apparatus can be configured such that the third link and the fourth link collectively have a closed configuration and an open configuration. When in the closed configuration and engaging the package, at least a portion of the distal end portion of the third link and at least a portion of the distal end portion of the fourth link are disposed within an opening of the package. In some implementations, when in the open configuration, the third link and the fourth link are outside of the opening of the package.

In some implementations, the apparatus is configured such that the third link and the fourth link collectively move from a closed configuration to an open configuration when the package is lowered to a landing surface and the first member moves lower causing the proximal end portion of the third link and the proximal end portion of the fourth link to lower away from the second member and causing the distal end portion of the third link and the distal end portion of the fourth link away from each other.

In some implementations, the apparatus is configured such that the third link and the fourth link collectively move from an open configuration to a closed configuration when a receptacle is lowered causing the third link and the fourth link to pivot with respect to the second end portion of the first link and the second end portion of the second link, respectively, causing the distal end portion of the third link and the distal end portion of the fourth link towards each other and causing at least a portion of the distal end portion of the third link and at least a portion the distal end portion of the fourth link to be disposed within an opening of the package.

In some implementations, the apparatus is configured such that the distal end portion of the third link includes a first elongate portion and a second elongate portion separated from the first elongate portion by a non-zero distance. The distal end portion of the fourth link can have an elongate portion sized and configured to be disposed between the first elongate portion of the distal end portion of the third link and the second elongate portion of the distal end portion of the third link when the third link and the fourth link are collectively in a closed configuration.

In some implementations, the apparatus is configured such that the first member, the second member, the first link, the second link, the third link and the fourth link collectively define a grasper. A receptacle is coupled to an aerial drone having a winch configured to retrieve the tether to move the grasper and the package towards the aerial drone and to pay out the tether to move the grasper and the package away from the aerial drone.

An apparatus according to an embodiment includes a first member, a second member configured to be coupled to a tether, a first link, a second link, and fourth link. The first link is pivotably coupled to the second member. The second link is pivotably coupled to the second member. The third link is pivotably coupled to the first member, pivotably coupled to the first link, and configured to be removably coupled to a package. The fourth link is pivotably coupled to the first member, pivotably coupled to the second link, and configured to be removably coupled to the package. The third link and the fourth link can collectively move from a closed configuration to an open configuration when (1) the package is lowered to a landing surface, (2) the second member is raised relative to the package, and (3) the first member moves lower relative to the second member causing a proximal end portion of the third link and a proximal end portion of the fourth link to lower and causing a distal end portion of the third link and a distal end portion of the fourth link away from each other. The third link and the fourth link can collectively move from the open configuration to the closed configuration when at least one of (1) the second member, the first link, the second link, the third link, the fourth link, and the first member, collectively, are at least partially received in a receptacle positioned above the second member, or (2) a package is raised into a slot defined by the first member. The at least one of the second member, the first link, the second link, the third link, the fourth link, and the first member, collectively, can be at least partially received in the receptacle or the package is raised into the slot defined by the first member causing the proximal end portion of the third link and the proximal end portion of the fourth link to move upward, causing the distal end portion of the third link and the distal end portion of the fourth link towards each other and causing at least a portion of the distal end portion of the third link and at least a portion the distal end portion of the fourth link to be disposed within an opening of the package.

In some implementations, the apparatus can be configured such that the third link includes a first portion and a second portion different from the first portion of the third link, in which the first portion of the third link includes the proximal end of portion of the third link. The fourth link can include a first portion and a second portion different from the first portion of the fourth link, in which the first portion of the fourth link includes the proximal end portion of the fourth link. The proximal end portion of the fourth link can be pivotably coupled to the proximal end portion of the third link. The first link, the second link, the first portion of the third link, and the first portion of the fourth link can collectively define a four-bar linkage.

In some implementations, the apparatus is configured such that the four-bar linkage collectively has a bias towards the open configuration. When in the closed configuration, the receptacle contacts the third link and the fourth link to overcome the bias towards the open configuration.

In some implementations, the apparatus is configured such that the four-bar linkage has a bias towards the open configuration. When moving from the closed configuration to the open configuration, the receptacle moves out of contact with the third link and the fourth link to remove a constraint on the bias.

In some implementations, the apparatus is configured such that the distal end portion of the third link includes a first elongate portion and a second elongate portion separated from the first elongate portion by a non-zero distance. The distal end portion of the fourth link can have an elongate portion sized and configured to be disposed between the first elongate portion of the distal end portion of the third link and the second elongate portion of the distal end portion of the third link when the third link and the fourth link are collectively in the closed configuration.

In some implementations, the apparatus can be configured such that the first member, the second member, the first link, the second link, the third link and the fourth link collectively define a grasper. The receptacle can be coupled to an aerial drone having a winch configured to retrieve the tether to move the grasper and the package towards the aerial drone and to pay out the tether to move the grasper and the package away from the aerial drone.

A method according to an embodiment includes moving a grasper from an open configuration to a closed configuration to grasp a package at a first location, the grasper including a first member, a second member configured to be coupled to a tether, a first link pivotably coupled to the second member, a second link pivotably coupled to the second member, a third link pivotably coupled to the first member and pivotably coupled to the first link, and a fourth link pivotably coupled to the second member and pivotably coupled to the second link. The moving the grasper from the open configuration to the closed configuration includes at least one of (1) moving at least a portion of the grasper into a receptacle slidably coupled to the tether or (2) raising the package into a slot defined by the first member. The at least one of the moving the at least the portion of the grasper or the raising causes a proximal end portion of a third link of the grasper and a proximal end portion of a fourth link of the grasper upward, causes a distal end portion of the third link and a distal end portion of the fourth link towards each other, and causes at least a portion of the distal end portion of the third link and at least a portion the distal end portion of the fourth link to be disposed within an opening of the package. The method also includes moving the grasper from the closed configuration to the open configuration to release the package at a second location different from the first location. The moving the grasper from the closed configuration to the open configuration includes lowering the package to a landing surface, raising the second member relative to the package after the lowering the package, and lowering the first member relative to the second member causing the proximal end portion of the third link and the proximal end portion of the fourth link to move downwards and causing the distal end portion of the third link and the distal end portion of the fourth link to move away from each other.

In some implementations, the grasper has a bias towards the open configuration, and when the grasper is in the closed configuration, the receptacle contacts the third link and the fourth link to overcome the bias towards the open configuration. In some implementations, the moving the grasper from the closed configuration to the open configuration includes slacking the tether to cause the receptacle to move out of contact with the third link and the fourth link. In some implementations, the moving the grasper from the open configuration to the closed configuration includes disposing an elongate portion of a distal end portion of the fourth link between a first elongate portion of the distal end portion of the third link and a second elongate portion of the distal end portion of the third link.

In some implementations, the receptacle is coupled to an aerial drone that has a winch configured to retrieve the tether to move the grasper and the package towards the aerial drone and configured to pay out the tether to move the grasper and the package away from the aerial drone. The receptacle can be in contact with the third link and the fourth link when the grasper is in the closed configuration, and the receptacle can be out of contact with the third link and the fourth link when the grasper is in the open configuration.

In some implementations, the third link includes a first portion and a second portion different from the first portion of the third link, and the fourth link includes a first portion and a second portion different from the first portion of the fourth link. The first portion of the fourth link can be pivotably coupled to the first portion of the third link, and the first link, the second link, the first portion of the third link, and the first portion of the fourth link can collectively define a four-bar linkage.

In some implementations, a distal end portion of the first member defines the slot configured to receive a portion of the package that includes the opening. When the grasper is in the closed configuration, the slot is configured to receive at least a portion of the distal end portion of the third link and at least a portion of the distal end portion of the fourth link.

### Drone Aerial Release Apparatus

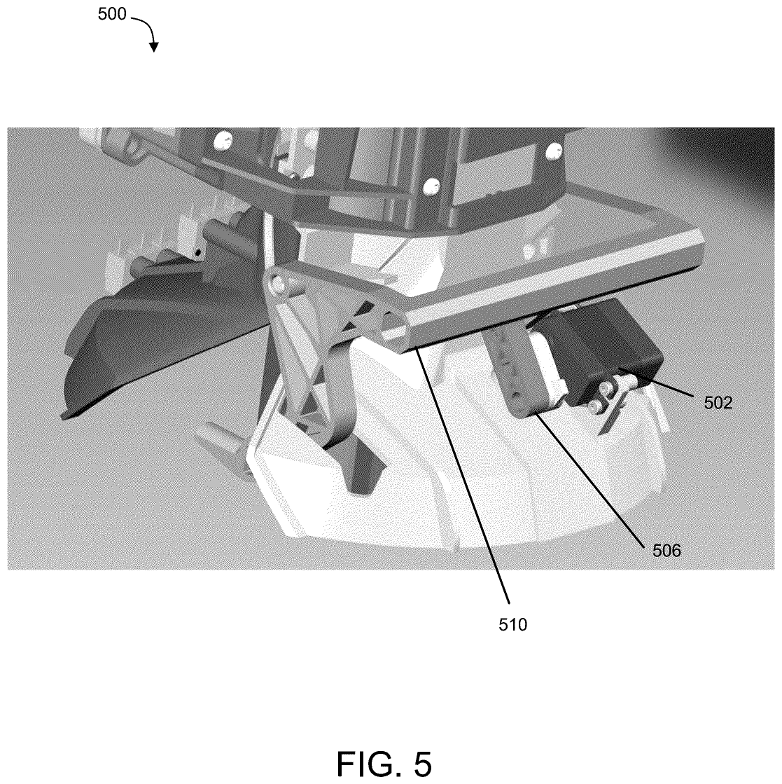

An apparatus 500 according to an embodiment is illustrated in FIGS. 5-6. The apparatus 500 can include or otherwise be coupled to, for example, a winch 600 (see, e.g., FIG. 6) coupled to an aerial vehicle (e.g., a drone) or another suitable vehicle described herein (not shown). The apparatus 500 is configured to decouple a package (e.g., package 106) from an aerial vehicle while said package is a non-zero distance or substantially above a landing surface (e.g., the ground, a landing pad, or other landing surface described herein). In this manner, the apparatus 500 can release a package from the air without needing to first placing the package onto the landing surface.

The apparatus 500 includes a controller 502 coupled to a hook 510. The hook 510 is configured to be selectively releasably coupled to the package. In some implementations, the hook 510 is selectively releasably coupled to the package independent of a grasper (e.g., grasper 102) being releasably coupled to the package. The hook 510 is configured to be coupled to the winch 600. For example, the hook 510 and/or controller 502 can be coupled to a receptacle (e.g., receptacle 702, described herein), which is coupled to the winch 600. The hook 510 is configured to move from a first position in which the hook is not coupled to the package 106 to a second position in which the hook is coupled to the package. Movement of the hook 510 from the first position to the second position can be, for example, in response to an engagement signal sent by the controller 502. In some implementations, the hook 510 is inserted into or through, or is otherwise at least partially received in, an opening (described in more detail herein) defined by the package 106 when the hook 510 is moved from the first position to the second position to engage or couple to the package 106. The hook 510 is configured to move from the second position to or towards the first position to release the package, for example, in response to the controller 502 sending a release signal. The hook 510 can move from the second position towards the first position from at least one of a location a non-zero distance above the landing surface or at the landing surface.

In some implementations, a selection signal can indicate whether the package is to be released from the location the non-zero distance above the landing surface or at the landing surface. In such implementations, the release signal can be defined in response to the selection signal, for example, in response to the selection signal indicating that the package is to be released form the location the non-zero distance above the landing surface.

The apparatus 500 can include an actuator 506 coupled to each of the hook 510 and the controller 502. The actuator 506 can be configured to move hook 510 from the second position towards the first position to release the package, for example, in response to receiving the release signal. In some implementations, the actuator 506 is configured to receive the release signal from the controller 502 while the aerial vehicle is in-flight and the hook 510 is coupled to the package. The actuator 506 is configured to move the hook 510 from the second position towards the first position while the aerial vehicle is in-flight, e.g., in response to receiving the release signal to cause the package to be released from the aerial vehicle.

The actuator 506 can be or include any one or more of a stepper motor, permanent magnet stepper, variable reluctance stepper, hybrid synchronous stepper, direct current (DC) electric motor, brushed DC motor, linear actuator, AC induction motor, or any other means of converting electrical energy into mechanical energy, or a combination thereof. Actuator 506 may be powered, directly or indirectly, by one or more batteries, DC power sources, capacitors, AC power sources, inverters, rectifiers, alternators, generators, or any other portable electrical power source suitable for an aerial vehicle. In some implementations, the actuator 506 is or includes a servo motor.

The apparatus 500 can include a receiver that is coupled to the controller 502, and that is configured to receive one or more signals. The receiver can be configured to receive the selection signal, for example while the aerial vehicle is in-flight and from a transmitter (not shown) that is not disposed with the aerial vehicle. The selection signal can indicate whether the package is to be released from the location substantially (i.e., a non-zero distance) above the landing surface, or at the landing surface. In some implementations, the receiver is configured to receive the selection signal not earlier than an initiation of flight for the package and of the aerial vehicle. In some implementations, the transmitter is configured to send the selection signal not earlier than an initiation of flight for the package and the aerial vehicle.

The one or more selection signals (or other signals) may conform to a wireless communications standard (e.g., a radio control standard, a WiFi® standard, a WLAN standard, a mesh network standard, an IEEE standard, an IEEE 802 standard, an IEEE 802.11 standard, an IEEE 802.15 standard, an IEEE 802.16 standard, a WiFi Alliance specification, a 3GPP standard, a mobile communication standard, a cellular communication standard, 3G/4G/LTE/5G/6G/7G/8G, an international standard, a national standard, an industry standard, or a de facto standard).

In some implementations, a processor (not shown) at the aerial vehicle can determine the selection signal, and the controller 502 can be configured to receive the selection signal from the processor.

The controller 502 can include one or more circuits configured to generate the release signal (e.g., an electronic signal). In some implementations, the controller defines said release signal in response to the selection signal (1) received while the aerial vehicle is in flight and/or (2) indicating that the package is to be released from the location the non-zero distance above the landing surface.

In some implementations, the apparatus 500 can include or be operably coupled to a processor (not shown), and optionally a memory operatively coupled to the processor. The processor can be or include, for example, a hardware based integrated circuit (IC), or any other suitable processing device configured to run and/or execute a set of instructions or code. For example, the processor can be a general-purpose processor, a central processing unit (CPU), an accelerated processing unit (APU), an application specific integrated circuit (ASIC), a field programmable gate array (FPGA), a programmable logic array (PLA), a complex programmable logic device (CPLD), a programmable logic controller (PLC) and/or the like. In some implementations, the processor can be configured to run any of the methods and/or portions of methods discussed. The memory can be or include, for example, a random-access memory (RAM), a memory buffer, a hard drive, a read-only memory (ROM), an erasable programmable read-only memory (EPROM), and/or the like. In some instances, the memory can store, for example, one or more software programs and/or code that can include instructions to cause the processor to perform one or more processes, functions, and/or the like. In some implementations, the memory can include extendable storage units that can be added and used incrementally. In some implementations, the memory can be a portable memory (e.g., a flash drive, a portable hard disk, and/or the like) that can be operatively coupled to the processor. In some instances, a memory can be remotely operatively coupled with a compute device (not shown). In some implementations, the apparatus 500 includes one or more circuits configured to release the package from a position either 1) substantially (i.e., a non-zero distance) above the landing surface or 2) at the landing surface, wherein configuration of the one or more processors is to be performed prior to an initiation of flight for the package and of the aerial vehicle.

The package to which the apparatus 500 can be selectively coupled can be similar or identical to any package described herein, such as package 106. The package can define one or more openings used to selectively releasably couple the package to the hook 510. In some implementations, the openings used to selectively releasably couple the package to hook 510 comprise the openings used to releasably couple package 106 to grasper 102, as described herein with respect to FIG. 1. In some implementations, the openings used to selectively releasably couple the package to hook 510 are disposed on the package a non-zero distance away from the openings used to releasably couple package 106 to grasper 102. In some implementations, the openings used to selectively releasably couple the package to hook 510 are disposed on a carrying handle of the package.

In some implementations, the apparatus 500 can also include the apparatus 100 and/or portions thereof. For example, the apparatus 500 can include a grasper, such as grasper 102, having a multi-bar linkage, such as multi-bar linkage 110. Accordingly, the grasper 102 is not described in detail with respect to apparatus 500. The grasper 102 can be configured to release, via the multi-bar linkage, the package at a landing surface in response to the package being lowered by the tether and the package contacting the landing surface, as described herein. The grasper 102 can also be configured to release, via the multi-bar linkage 110, the package in response to the grasper and package being lowered by the tether 104 when the hook is coupled to the package (e.g., the second position), as described in more detail below.

The grasper 102 can be configured to be coupled to the winch 600 by a tether (e.g., tether 104). The multi-bar linkage 110 of the grasper 102 can be configured to be releasably coupled to the package. The multi-bar linkage 110 of the grasper 102 can include a first portion and a second portion, with the first portion of the multi-bar linkage configured to be disposed on a first side of the package when coupled to the package, and the second portion of the multi-bar linkage configured to be disposed on a second side of the package when coupled to the package. The grasper 102 can be configured to release the package via the first portion of the multi-bar linkage and the second portion of the multi-bar linkage from the location the non-zero distance above the landing surface. The grasper 102 can include a spring, such as spring 2202 described in more detail herein, configured to apply a spring force to move the first portion of the multi-bar linkage and the second portion of the multi-bar linkage away from the package during the release. In some implementations, the grasper 102 can be configured to release the package to the hook 510 via the first portion of the multi-bar linkage 110 and the second portion of the multi-bar linkage 110. In some implementations, the grasper 102 includes a spring (e.g., spring 2202) configured to bias the multi-bar linkage 110 towards an open configuration.

As discussed above, the apparatus 100 can include the tether 104 and the winch (e.g., winch 600 shown in FIG. 6). The winch is configured to pay out the tether and thereby lower the grasper and the package releasably coupled to the grasper away from the aerial vehicle, and optionally towards one or both of the hook 510 or the landing surface. The winch 600 can comprise an electro-mechanical device configured to retrieve, pull in, wind up, pay out, let out, wind out, and/or otherwise adjust the tension of a tether (e.g., tether 104). The winch 600 can be configured to accumulate the tether 104 on, for example, a spool, drum, capstan, or cylindrical element. The winch 600 can comprise, for example, one or more gear assemblies, solenoid brakes, mechanical brakes, ratchets, or pawls. The winch 600 can also include an electric, hydraulic, pneumatic, or internal combustion drive configured to power the winch to operably retrieve and/or pay out the tether 104.

If the selection signal indicates that the package is to be released at the landing surface, the hook 510 can selectively not be engaged with the package. Said another way, the hook 510 can be in its first position while the apparatus 100 (and grasper 102 thereof) releases the package at the landing surface as described above with respect to FIGS. 1-4, which can include lowering the package coupled to the grasper to the landing surface via the winch 600 and tether 104. More specifically, the winch 600 is configured to lower the tether 104 while the aerial vehicle is a non-zero distance above the landing surface and until the package contacts the landing surface when the release signal is not sent by the controller 502. As such, the grasper is configured to release the package at the landing surface upon contacting the landing surface in response to the selection signal indicating that the package is to be released at the landing surface.

In some implementations, the grasper 102 is releasably coupled to the package, e.g., before the package is engaged with or releasably coupled to hook 510. In some implementations, the hook 510 is configured to engage with the package in response to the selection signal indicating that the package is to be released a non-zero distance above the landing surface. If the selection signal indicates that the package is to be released the non-zero distance above the landing surface, the hook moves from the first position to the second position to be selectively releasably coupled to the package 106. For example, the hook 510 can be at least partially received in the opening defined by the package 106 when the hook is in the second position, thereby being releasably coupled to the package 106. The winch 600 pays out the tether 104 to move the grasper 102 and the package 106 releasably coupled to the grasper 102 towards hook 510, when the hook 510 is in the second position. After the package 106 is releasably coupled to hook 510 and the winch further pays out the tether 104, the tension force applied to the tether 104 is removed or substantially reduced (i.e., the tether is slackened) as a result of the package 106 resting on the hook 510. In other words, when the hook 510 is in the second position coupled to the package 106, the hook 510 limits downward movement of the package with respect to the grasper 102 even if the winch continues to pay out the tether 104. In a similar manner as described above with respect to FIGS. 1-4 when the grasper 102 released the package to the landing surface, removal or substantial reduction of the tension force applied to the tether causes or allows the second member 112 to descend toward the first member 108 and therefore the grasper 102 can move from the closed configuration to the open configuration as described above. In some implementations, the hook 510 is moved towards its first position to uncouple the hook 510 from the package 106, for example, during a time that is substantially concurrently with, overlapping with, or substantially immediately following a time when tension force that is applied to the tether is removed or substantially reduced. In this manner, as the hook 510 is uncoupled (for example, clears the opening on the package 106 as the hook 510 is uncoupled) from the package 106, the package 106 and grasper 102 can descend under gravity force, and the grasper 102 releases the package 106 (e.g., via the first potion of the multi-bar linkage and the second portion of the multi-bar linkage).

In some implementations, the hook 510 can be configured to lift the package when the hook 510 is coupled to the package and the grasper is releasably coupled to the package (e.g., without the winch paying out the tether 104). For example, the actuator 506 can move to pivot the hook 510 to lift the package. As a result of the hook 510 lifting the package, the tension force applied to the tether is substantially reduced, causing the grasper to decouple, via the multi-bar linkage 110, from the package. As a result of the grasper decoupling from the package, hook 510 can be used to release the package while the aerial vehicle is above the landing position.

In some implementations, the grasper 102 is configured to move to the open configuration when the hook 510 is in the second position releasably coupled to the package, and so the grasper 102 releases the package 106 to hook 510 (e.g., via the first potion of the multi-bar linkage and the second portion of the multi-bar linkage) from the non-zero distance above the landing surface. The hook 510 can be configured to release the package after the grasper 102 has released the package to the hook 510 and from the location the non-zero distance above the landing surface in response to the release signal.

The release signal can be generated by the controller 502 and received by the actuator 506. In some implementations, a control signal is sent from the controller to cause a portion of the actuator 506 to rotate, thereby retracting a portion of hook 510 from the one or more openings defined by the package. For example, movement of the actuator 506 can pivot the hook 510 from the second position in which hook 510 is coupled to the package towards the first position in which the hook 510 is not coupled to the package in response to the controller sending the release signal.

Although the apparatus 500 has been described thus far as including a hook 510, in some embodiments, the hook is a first hook and the apparatus 500 includes a second hook 516 and an elongate member 512, as shown in FIGS. 5-6. The first hook 510 can be coupled to a first end portion of the elongate member 512, and the second hook 516 can be coupled to a second end portion of elongate member 512. The first end portion of the elongate member 512 can be substantially opposite the second end portion of the elongate member 512.

In some implementations, second hook 516 is configured to be selectively releasably coupled to the package and independent of the grasper being independently coupled to the package. Although the hook 510 of apparatus 500 is shown and described with respect to FIGS. 5-6 as including two hooks 510, 516, in some implementations, the hook 510 can include three or more hooks, or a single hook. The first hook 510 and second hook 516 can each comprise a first portion proximal to elongate member 512 and a second portion substantially opposite the first portion, the first portion and the second portion being substantially orthogonal to each other. In some implementations, first hook 510 and second hook 516 are substantially J-shaped, L-shaped, C-shaped, U-shaped, or any other shape configured such that hook 510 can be selectively releasably coupled to the package.

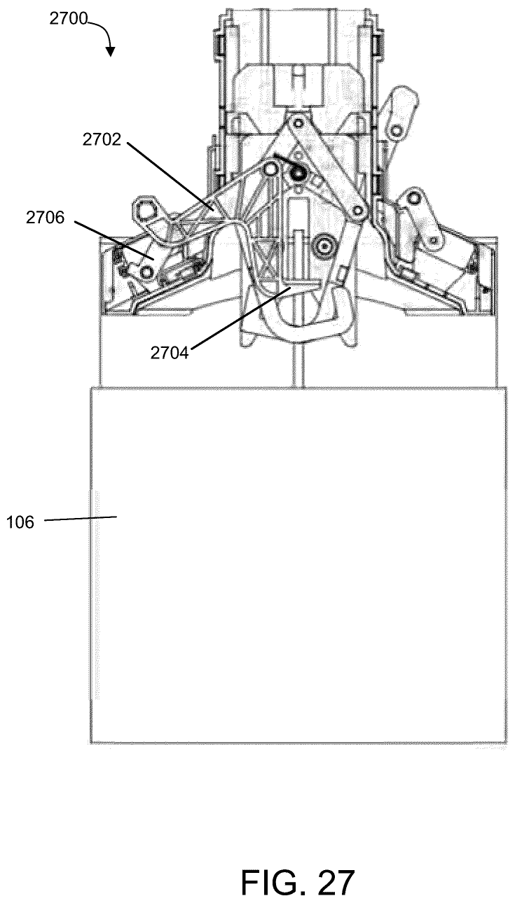

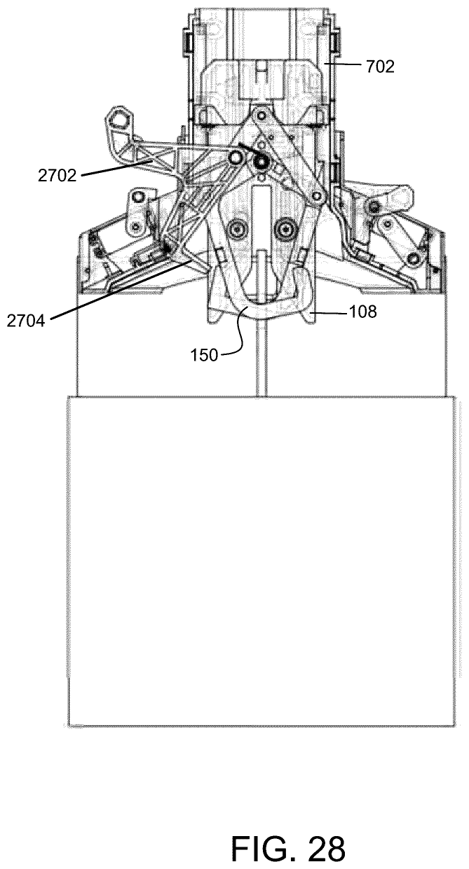

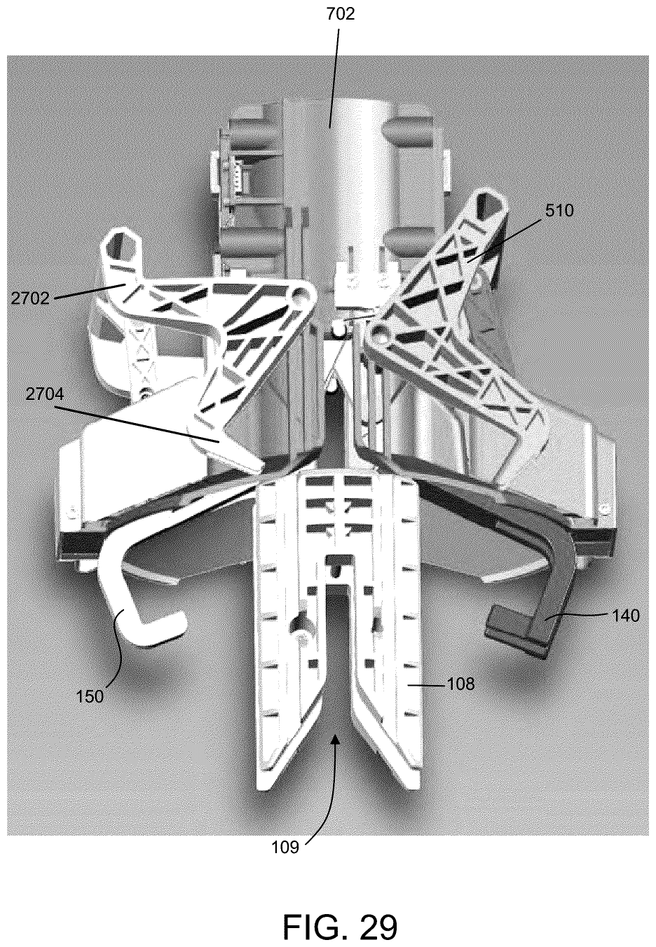

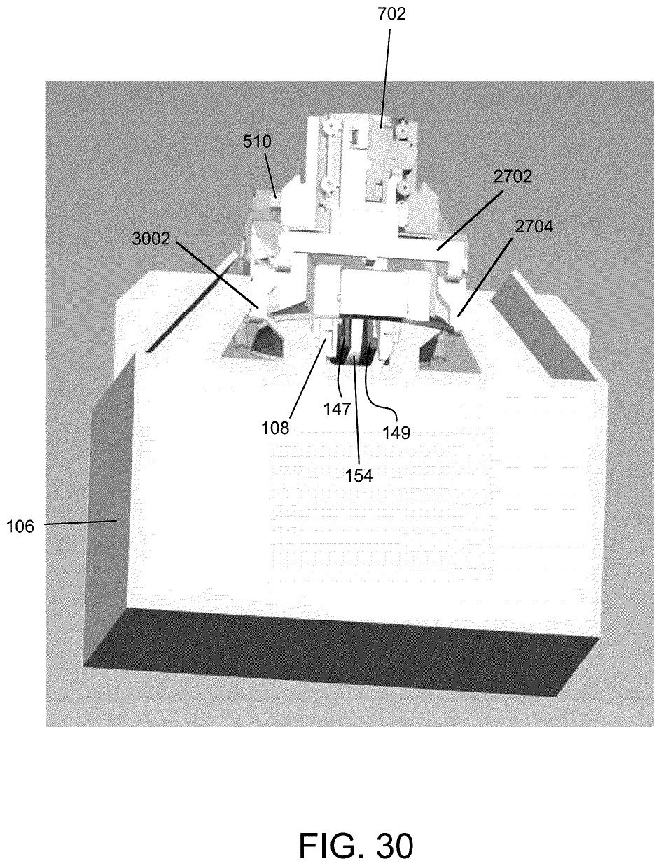

In some implementations, an apparatus 2700 can include a flight lock 2702 (see, e.g., FIGS. 27-30) configured to prevent a package 106 from decoupling from the apparatus 2700. The apparatus 2700 can include the apparatus 500, the apparatus 100, and/or portions thereof. The flight lock 2702 can include a hook 2704 (see, e.g., FIGS. 27-30) and a hook 3002 (see, e.g., FIG. 30). At least a portion of the hooks 2704 and/or 3002 can be configured to be disposed in an opening(s) included in the package 106 (e.g., an opening(s) associated with a handle or gable disposed on the package 106) when the flight lock 2702 is in a first position. The apparatus 2700 can further include an actuator 2706 coupled to the flight lock 2702 (see, e.g., FIG. 27). The actuator 2706 can be configured to move the flight lock 2702 (e.g., in response to receiving a lock signal transmitted from a controller) from a second position towards the first position to prevent the package from being released and/or lowered via the tether 104. The actuator 2706 can be further configured to move the flight lock 2702 (e.g., in response to receiving an unlock signal transmitted from a controller) from the first position to the second position to cause the hooks 2704 and 3002 to be retracted from the opening of the package 106, permitting the package 106 to be lowered for engagement by a hook (e.g., hook 510) for aerial release and/or lowered via the tether 104.

An apparatus according to an embodiment includes a winch configured to be coupled to an aerial vehicle, and a grasper having a multi-bar linkage. The grasper can be configured to be coupled to the winch by a tether, and the multi-bar linkage of the grasper can be configured to be releasably coupled to a package. A hook can be configured to be coupled to the winch, the hook configured to be selectively releasably coupled to the package independent of the grasper being releasably coupled to the package. A controller can be coupled to the hook, and the hook can be configured to move from a first position in which the hook is not coupled to the package to a second position in which the hook is coupled to the package, in response to an engagement signal sent by the controller. The grasper can be configured to release, via the multi-bar linkage, the package (1) at a landing surface in response to the package being lowered by the tether and the package contacting the landing surface and (2) from a location a non-zero distance above the landing surface in response to the hook being moved from the second position towards the first position concurrently with a tension in the tether being removed or substantially reduced. In some implementations, the grasper can be configured to release, via the multi-bar linkage, the package (1) at a landing surface in response to the package being lowered by the tether and the package contacting the landing surface and (2) to the hook in response to the package being lowered by the tether when the hook is coupled to the package. The hook can be configured to move from the second position towards the first position, for example, to release the package, in response to the controller sending a release signal.

In some implementations, the apparatus can also include an actuator coupled to the hook and the controller, the actuator configured to receive the release signal from the controller and to move the hook from the second position towards the first position. In some implementations, the hook is configured to release the package in response to receiving the release signal. In some implementations, the actuator can be configured to receive the release signal from the controller while the aerial vehicle is in-flight and the hook is coupled to the package. The actuator can be further configured to move the hook from the second position towards the first position while the aerial vehicle is in-flight, and optionally in some implementations while the grasper is not coupled to the package, in response to receiving the release signal to cause the package to be released from the aerial vehicle.

In some implementations, the apparatus can comprise a receiver coupled to the controller, the receiver configured to receive a selection signal while the aerial vehicle is in-flight from a transmitter not disposed with the aerial vehicle. The selection signal can indicate whether the package is to be released from the location the non-zero distance above the landing surface or at the landing surface. The release signal can be defined in response to the selection signal indicating that the package is to be released from the location the non-zero distance above the landing surface.

In some implementations, the receiver is configured to receive the selection signal not earlier than an initiation of flight for the package and of the aerial vehicle. In some implementations, the multi-bar linkage includes a first portion and a second portion, the first portion of the multi-bar linkage being disposed on a first side of the package when coupled to the package and the second portion of the multi-bar linkage being disposed on a second side of the package opposite the first side of the package when coupled to the package. The grasper can be configured to release the package via the first portion of the multi-bar linkage and the second portion of the multi-bar linkage from the location the non-zero distance above the landing surface. The grasper can include a spring configured to apply a spring force to move the first portion of the multi-bar linkage and the second portion of the multi-bar linkage away from the package during the release, as described in more detail herein. The release signal can be defined in response to a selection signal (1) received while the aerial vehicle is in-flight and (2) indicating that the package is to be released from the location the non-zero distance above the landing surface. The hook can be configured to release the package (1) after the grasper has released the package and (2) from the location the non-zero distance above the landing surface in response to the release signal.

In some implementations, the winch is configured to lower the tether while the aerial vehicle is a non-zero distance above the landing surface and until the package contacts the landing surface when the release signal is not sent by the controller.

In some implementations, the hook is a first hook, and the apparatus can also include an elongate member and a second hook. The first hook can be coupled to a first end portion of the elongate member, and the second hook can be coupled to a second end portion of the elongate member. The second hook can be configured to be selectively releasably coupled to the package and independent of the grasper being releasably coupled to the package. The apparatus can also include an actuator coupled to the winch and configured to move the first hook and the second hook, in response to the release signal, to release the package from the first hook and the second hook from at least one of the location the non-zero distance above the landing surface or at the landing surface.

An apparatus according to an embodiment includes a winch configured to be coupled to an aerial vehicle, a grasper configured to be coupled to the winch, the grasper configured to be releasably coupled to a package. The apparatus can also include a hook configured to be coupled to the winch, the hook configured to be releasably coupled to the package independent of the grasper. The apparatus can also include a receiver configured to receive a selection signal while the aerial vehicle is in-flight from a transmitter not disposed with the aerial vehicle, the selection signal indicating whether the package is to be released from a location a non-zero distance above the landing surface or at the landing surface. The hook is configured to engage the package, and is further configured to release the package while the aerial vehicle is in-flight and in response to the selection signal indicating that the package is to be released. The grasper is configured to release the package while the aerial vehicle is in-flight. The grasper is further configured to release the package at the landing surface upon contacting the landing surface in response to the selection signal indicating that the package is to be released at the landing surface.

In some implementations, the receiver is configured to receive the selection signal while the aerial vehicle is in-flight and not earlier than an initiation of flight for the package and of the aerial vehicle. In some implementations, the hook is a first hook, and the apparatus can also include an elongate member, the first hook coupled to a first end portion of the elongate member, and a second hook coupled to a second end portion of the elongate member, the second hook configured to be selectively releasably coupled to the package and independent of the grasper being releasably coupled to the package. The apparatus can further comprise an actuator coupled to the winch and configured to move the first hook and the second hook, in response to the release signal, to release the package from the first hook and the second hook from at least one of the location the non-zero distance above the landing surface or the landing surface.

In some implementations, the apparatus can further comprise a controller coupled to the receiver and an actuator coupled to the hook and the controller. The actuator can be configured to receive a release signal from the controller while the aerial vehicle is in-flight. The grasper can be coupled to the package and the selection signal indicates the package is to be released from the location the non-zero distance above the landing surface, and the actuator can be configured to pivot the hook with respect to the grasper while the aerial vehicle is in-flight and the grasper is coupled to the package in response to receiving the release signal to couple the hook to the package. The actuator can be configured to pivot the hook with respect to the grasper while the aerial vehicle is in-flight and after the grasper is lowered towards the hook by the winch when the hook is coupled to the package to uncouple the hook from the package. The grasper can be configured to release the package from the location the non-zero distance above the landing surface in response to the hook being uncoupled from the package.

In some implementations, the grasper can include a multi-bar linkage having a first portion and a second portion, the first portion of the multi-bar linkage being disposed on a first side of the package when coupled to the package and the second portion of the multi-bar linkage being disposed on a second side of the package opposite the first side of the package when coupled to the package. The grasper can be configured to move the first portion of the multi-bar linkage and the second portion of the multi-bar linkage away from each other to release the package via the first portion of the multi-bar linkage and the second portion of the multi-bar linkage from the location the non-zero distance above the landing surface in response to the signal received from the controller and the grasper being lowered towards the hook by the winch.

A method according to an embodiment includes receiving a selection signal at an aerial vehicle while the aerial vehicle is in-flight, the selection signal indicating whether a package carried by the aerial vehicle is to be released from a location a non-zero distance above a landing surface or at the landing surface. The method can also include retracting a multi-bar linkage of a grasper, while the aerial vehicle is in-flight and the grasper is coupled to the package, in response to receiving the selection signal indicating the package is to be released from the aerial vehicle from the position over the landing surface. The method can also include moving, while the aerial vehicle is in-flight and via an actuator, a hook from a position in which the hook is coupled to the package to a position in which the hook is uncoupled from the package, in response to receiving the selection signal indicating the package is to be released from the aerial vehicle from the position over the landing surface. The method can also include retracting the multi-bar linkage of the grasper in response to the package contacting the landing surface after receiving the selection signal indicating the package is to be released at the landing surface.

In some implementations, the method can include moving, before the retracting the multi-bar linkage of the grasper while the aerial vehicle is in-flight and via the actuator, the hook to the position in which the hook is coupled to the package while the aerial vehicle is in-flight and the grasper is coupled to the package, in response to receiving the selection signal indicating the package is to be released from the aerial vehicle from the position over the landing surface.

In some implementations, the method can include determining the selection signal at a processor at the aerial vehicle, and the receiving can include receiving the selection signal at a controller at the aerial vehicle and from the processor. In some implementations, the method can further comprise lowering a tether coupled to the grasper while the aerial vehicle is above the landing surface and until the package contacts the landing surface, after receiving the selection signal indicating the package is to be released at the landing surface. The retracting the multi-bar linkage of the grasper can be in response to the package contacting the landing surface being after the lowering.

In some implementations, the multi-bar linkage can include a first portion and a second portion, the first portion of the multi-bar linkage disposed on a first side of the package when coupled to the package, the second portion of the multi-bar linkage disposed on a second side of the package opposite the first side of the package when coupled to the package. The retracting the multi-bar linkage while the aerial vehicle is in-flight can include retracting the first portion of the multi-bar linkage and the second portion of the multi-bar linkage away from each other while the aerial vehicle is in-flight in response to (1) the tether being lowered with respect to the hook while the hook is coupled to the package, and (2) the hook being uncoupled from the package after the tether is lowered. The retracting in response to the package contacting the landing surface can include retracting the first portion of the multi-bar linkage and the second portion of the multi-bar linkage away from each other in response to the tether being lowered and the package contacting the landing surface.

In some implementations, the receiving can include receiving the selection signal at a receiver coupled to a controller that is coupled to the actuator, and the moving the hook via the actuator can include sending a control signal from the controller to rotate a portion of the actuator to retract a portion of the hook from an opening defined by the package.

In some implementations, the method can also include contracting, before the receiving and before an initiation of flight for the package and of the aerial vehicle, the multi-bar linkage to couple the grasper to the package, the selection signal not being received at the aerial vehicle before the initiation of the flight for the package and of the aerial vehicle.

### Drone Grasper Alignment

Referring to FIGS. 7-9, an apparatus 700 according to an embodiment is configured to align a grasper to a receptacle, for example for docking the grasper when the grasper is not in use. The apparatus 700 can include a receptacle (e.g., receptacle 702), a winch (e.g., winch 600) configured to be coupled to the receptacle 702 and to an aerial vehicle (not shown), and a grasper (e.g., grasper 102). The grasper 102 is described in detail above, and so is not described in detail with respect to FIGS. 7-9. The grasper 102 is configured to be coupled to the winch 600 by a tether (e.g., tether 104). The grasper 102 is configured to be rotated to a predefined alignment relative to the receptacle 702, for example, upon retrieval of the tether 104 coupled to the grasper 102 by the winch 600 to dock the grasper 102 to the receptacle 702 when the grasper 102 is not in use to transport a package. The predefined alignment can include, for example, one of two grasper 102 orientations (e.g., a first alignment and a second alignment rotated substantially 180 degrees relative to the first alignment).

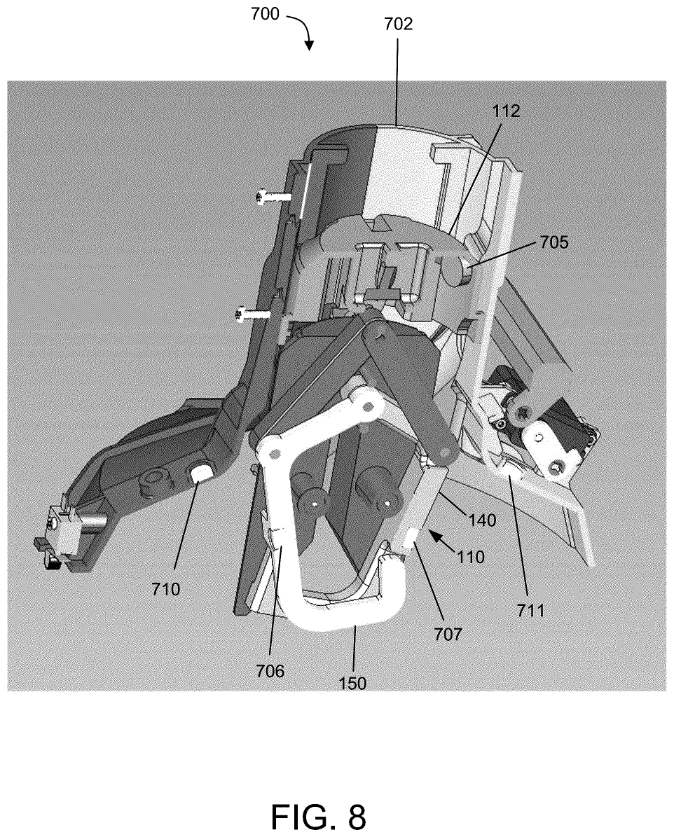

The grasper 102 includes a multi-bar linkage (e.g., multi-bar linkage 110) configured to be releasably coupled to a package (e.g., package 106). The grasper can be configured to be rotated to a predefined alignment as the winch 600 raises the grasper 102 and the grasper comes within a predetermined distance of and/or contacts the receptacle 702. In one example, the apparatus 700 can include a magnet positioned to cause the grasper 102 to rotate to the predefined alignment relative to the receptacle 702. In some implementations, the multi-bar linkage includes a link (e.g., 120, 130, 140, 150) and the link includes a magnet. For example, link 140 can include a magnet 707 and/or link 150 can include a magnet 706, as shown in FIG. 8. In some implementations, the second member 112 of the grasper 102 alternatively or additionally includes one or more magnets (e.g., magnet 704 shown in FIG. 7 and/or magnet 705 shown in FIG. 8).

The receptacle 702 includes one or more magnets positioned to magnetically couple to or magnetically repel the magnet of the link and/or the grasper to rotate the grasper 102 into the predefined alignment. For example, the receptacle 702 can include a magnet (e.g., magnet 708 and/or magnet 709), which can be disposed on a first portion of the receptacle that is above a second portion of the receptacle. In use, the magnet 708 or 709 of the receptacle 702 can repel the magnet 704 or 705 of the second member 112 of the grasper 102. In another example, the receptacle 702 can include a magnet (e.g., magnet 710 and/or magnet 711), which can be disposed on the second portion of the receptacle. As such, as the tether 104 is taken up by the winch 600, if the grasper 102 is rotated approximately 90 degrees with respect to the receptacle 702 from the orientation of the grasper with respect to the receptacle shown in FIGS. 7-9, the magnet(s) 704, 705 of the grasper 102 will be repelled by the magnet(s) of the receptacle 702 such that the grasper rotates about tether towards the alignment position shown, e.g., in FIG. 7 or 8 or to an alignment position that is substantially 180 degrees from the alignment position shown, e.g., in FIG. 7 or 8.

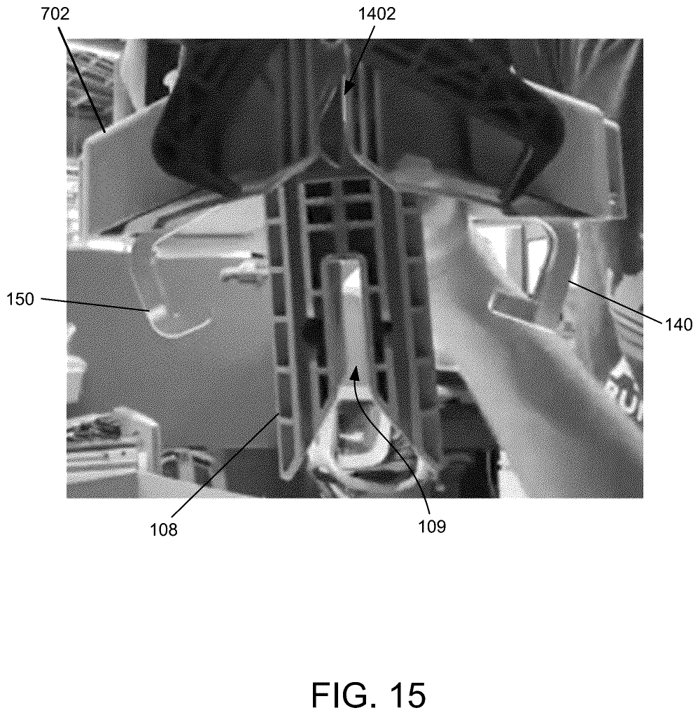

In some implementations, the magnet 710 or 711 of the receptacle can attract the magnet 706 or 707 of the link 150. As such, as the tether 104 is taken up by the winch 600, the magnet(s) 706, 707 of the link 150, 140 can be attracted by the magnet(s) 710, 711 of the receptacle 702 such that the grasper rotates about tether towards the alignment position shown, e.g., in FIG. 7 or 8 or to an alignment position that is substantially 180 degrees from the alignment position shown, e.g., in FIG. 7 or 8. The magnetic attraction of the magnets 706, 707 and magnets 710, 711 can be greater when pairs of the magnets (e.g., one of magnets 706 or 707 and one of magnets 710 or 711) are closer in proximity, such as when the grasper 102 is in the open configuration (e.g., after delivering or releasing a package). As shown in FIG. 15, as a result of this proximity, the magnetic attraction of the magnets 706, 707 and magnets 710, 711 helps to maintain the grasper 102 in an open configuration. Said differently, the magnetic attraction can cause the third link 140 and the fourth link 150 to be releasably coupled to the receptacle 702.

In use (e.g., during package pickup), a package (e.g., the package 106) can be lifted towards the grasper 102 (as described herein) when the grasper is in the open configuration (e.g., when the third link 140 and the fourth link 150 are releasably coupled to the receptacle 702, as shown in FIG. 15) and the tether 104 can be taken up by the winch 600 to raise the grasper 102 such that the grasper 102 is at least partially disposed within the receptacle 702. The receptacle 702 can be configured (e.g., via the guide portion 718, as described herein) to cause the grasper 102 to transition from the open configuration to the closed configuration when the grasper 102 is raised into the receptacle 702, overcoming the magnetic attraction between the pair of magnets (e.g., one of magnets 706 or 707 and one of magnets 710 or 711), such that the links 140, 150 are moved towards each other until they are disposed through the package opening and the package is releasably coupled to the grasper 102. The winch 600 can continue to retrieve the tether 104 to raise the grasper 102 and the releasably coupled package 106 into at least a portion of the receptacle 702. In this manner, when the tether 104 is sufficiently tensioned to retain the grasper 102 at least partially in the receptacle 702, the receptacle 702 helps to retain the grasper 102 in the closed configuration.

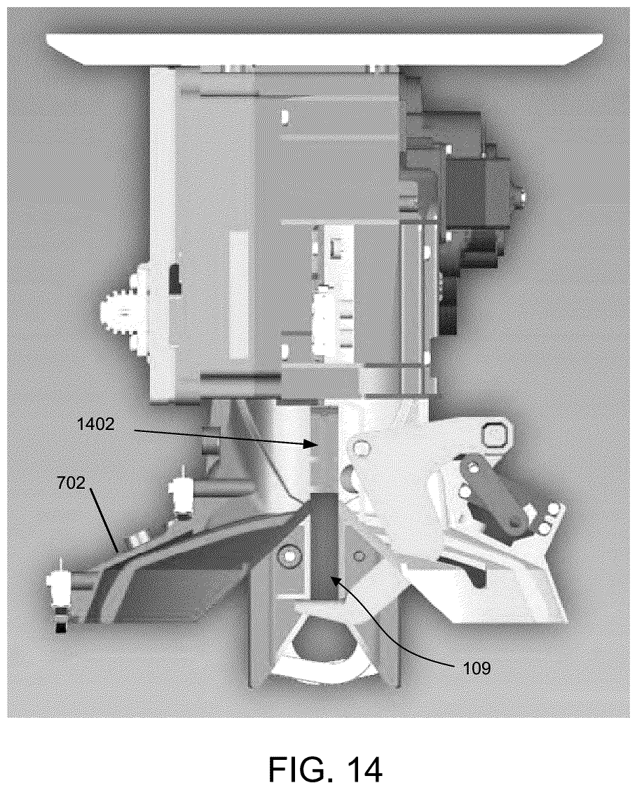

In some implementations, as shown in FIGS. 14 and 15, the receptacle 702 can include a slot 1402 that is configured to receive at least a portion (e.g., the handle) of the package 106. This portion of the package 106 can be disposed in the slot 109 of the first member 108 as a result of the package being releasably coupled to the grasper 102. The slot 1402 can be configured such that the receptacle 702 does not impede the package 106 as the tether 104 (via the winch 600) lifts the grasper 102 and the releasably coupled package 106. In some implementations, the slot 1402 of the receptacle 702 can have a width that is substantially equivalent to the width of the slot 109 of the first member 108. In some implementations, the grasper 102 can be aligned relative to the receptacle 702 (e.g., according to a predefined alignment, as described herein) as the tether 104 lifts at least a portion of the grasper 102 into at least a portion of the receptacle 702, such that the handle of the package 106 is disposed in both the slot 109 of the first member 108 and the slot 1402 of the receptacle 702.

Each magnet described herein can be or include neodymium, samarium cobalt, alnico, ferrite, flexible rubber, or any other permanent magnet material. In some implementations, the magnet can be or include an electromagnet.

In some implementations, the grasper 102 can include a first magnet and a second magnet (e.g., one of magnets 704, 705 and one of magnets 706, 707, respectively), and the receptacle 702 can include a first magnet and a second magnet (e.g., one of magnets 708, 709, and one of magnets 710, 711, respectively). The first magnet of the grasper 102 and the first magnet of the receptacle 702 can be configured to repel each other (e.g., the first magnet of the grasper and the first magnet of the receptacle are oriented such that a pole of the first magnet of the grasper like the pole of the first magnet of the receptacle is oriented towards said pole of the first magnet of the receptacle). The second magnet 706 of the grasper 102 and the second magnet 710 of the receptacle 702 can be configured to attract each other (e.g., the second magnet of the grasper and the second magnet of the receptacle are oriented such that a pole of the second magnet of the grasper unlike the pole of the second magnet of the receptacle is oriented towards said pole of the second magnet of the receptacle).

In some implementations, the grasper 102 includes four magnets (e.g., magnets 704, 705, 706, 707) and the receptacle 702 includes four magnets (e.g., magnets 708, 709, 710, 711). The grasper 102 can have a first portion and a second portion (and the multi-bar linkage can correspondingly have a first portion and a second portion) in which the first portion of the grasper (and multi-bar linkage) is disposed on or to a first side of the package when coupled to the package and the second portion of the grasper (and multi-bar linkage) is disposed on or to a second side of the package opposite the first side of the package when coupled to the package.

For example, the first portion of the grasper 102 includes a first magnet 704 (e.g., on the second member 112) and a second magnet 706 (e.g., on the multi-bar linkage 110), and the second portion of the grasper includes a first magnet 705 (e.g., on the second member 112) and a second magnet 707 (e.g., on the multi-bar linkage 110). The receptacle 702 can comprise a first magnet 708, second magnet 709, a third magnet 710, and a fourth magnet 711, wherein first magnet 708 and second magnet 709 are disposed on the first or upper portion of receptacle 702, and the third magnet 710 and fourth magnet 711 are disposed on the second or lower portion of receptacle 702. The first magnet 704 of the first portion of the grasper 102 and the first magnet 705 of the second portion of the grasper 102 can be configured to repel the first magnet 708 of receptacle 702 and the second magnet 709 of receptacle 702, respectively, such that the grasper is rotated if the grasper orientation is approximately 90 degrees off from its destination orientation. The grasper 102 can be rotatable in a first direction and a second direction opposite the first direction as the winch raises the grasper. For example, during use, the grasper 102 can rotate in the first direction to the predefined alignment (e.g., the first alignment) as the winch 600 raises the grasper and the grasper contacts the receptacle 702 during a first time period, and the grasper 102 can rotate in the second direction to the predefined alignment (e.g., the second alignment) as the winch 600 raises the grasper and the grasper contacts the receptacle during a second time period mutually exclusive from the first time period. The second magnet 706 of the first portion of the grasper (e.g., of the multi-bar linkage of the grasper) and the second magnet 707 of the second portion of the grasper (e.g., of the multi-bar linkage of the grasper) are configured to be attracted to the third magnet 710 of receptacle 702 and the fourth magnet 711 of receptacle 702, respectively, and can optionally releasably couple the grasper to receptacle 702. In some implementations, the grasper 102 and receptacle 702 can each comprise a different number of magnets (e.g., one, two, three, four, five or more magnets) configured to rotate the grasper to the predefined alignment and optionally releasably couple the grasper to receptacle 702.

In some implementations, receptacle 702 includes one or more elongate extrusions configured to maintain the grasper in the predefined alignment should the second magnet 706 of the first portion of the grasper 102 and the second magnet 707 of the second portion of the grasper be disposed above the third magnet 710 of receptacle 702 and the fourth magnet 711 of receptacle 702, respectively, e.g., as a result of the winch retrieving the tether by a sufficient amount to draw at least a portion of the grasper into the first portion of the receptacle.

The receptacle 702 can be configured to at least partially receive at least one of the second member 112 of the grasper 102, a first link 120 of the grasper, a second link 130 of the grasper, a third link 140 of the grasper, a fourth link 150 of the grasper, and the first member 108 of the grasper. The receptacle 702 can be configured such that the grasper 102 moves to or maintains a closed configuration as at least a portion of the grasper is received in the receptacle 702. The receptacle 702 can be further configured to at least partially receive the package (e.g., package 106 of FIG. 1). In some implementations, the as the package (e.g., package 106) and grasper 102 ascend into the receptacle 702, the package (e.g., a handle or gable of the package) can contact or move into a predetermined distance from a proximity sensor disposed in the receptacle. In response to the proximity sensor detecting the package, a signal can be sent for the winch to reel in line slack until line tension is sensed and sufficient to retain the package. In some implementations, the grasper can be in a closed configuration when the third link 140 and the fourth link 150 of the grasper 102 are in contact with an interior surface of the receptacle 702.

FIG. 9 shows a guide portion 718 of receptacle 702 configured to help rotate the grasper 102 to the predefined alignment relative to the receptacle, according to an embodiment. Guide portion 718 can be configured to rotate the grasper 102 to the predefined alignment when the grasper contacts guide portion 718 as the winch raises the grasper at least partially into the receptacle 702. First magnet 704 of the first portion of the grasper 102 and first magnet 705 of the second portion of the grasper can rotate the grasper prior to contacting receptacle 702, such that the orientation of the grasper approximates the predefined alignment prior to the grasper contacting guide portion 718 of receptacle 702. Then, guide portion 718 can be configured to rotate the grasper towards the predefined alignment as the winch raises the grasper and the grasper (e.g., an outer surface thereof) contacts guide portion 718 of receptacle 702. More specifically, the guide portion 718 can narrow from a first location 720 of receptacle 702 (e.g., having a width W1) to a second location 722 of receptacle 702 (e.g., having a width W2 less than the width W1 of the first location), such as via sloped surfaces or ramps from the first location to the second location.

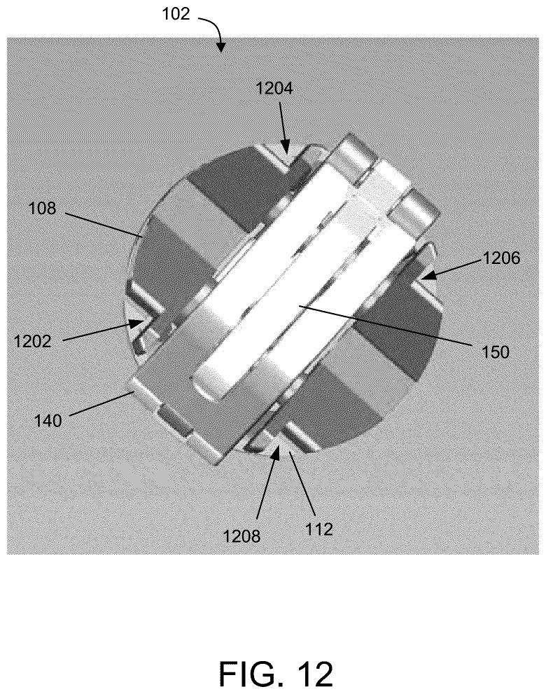

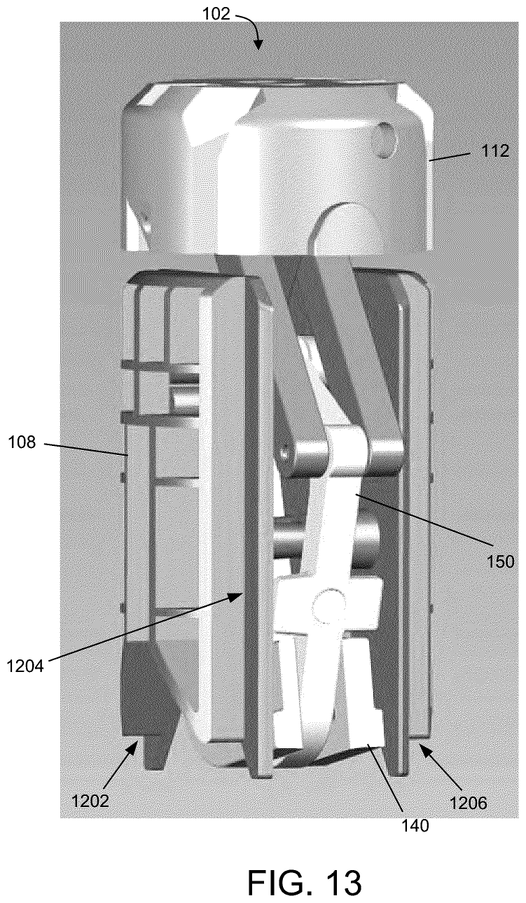

As shown in FIGS. 12, 13, 15, and 16 the first member 108 of the grasper 102 can include or define one or more elongate channels (e.g., channels 1202, 1204, 1206, and 1208) (e.g., on an outer surface of the first member 108) that are oriented vertically (e.g., in parallel to the length of the slot 109 of the first member 108 and/or the length of the slot 1402 of the receptacle 702) and are configured to substantially maintain the predefined alignment of the grasper 102 when at least a portion of the elongate channels (e.g., channels 1202, 1204, 1206, and 1208) is disposed within the receptacle 702.

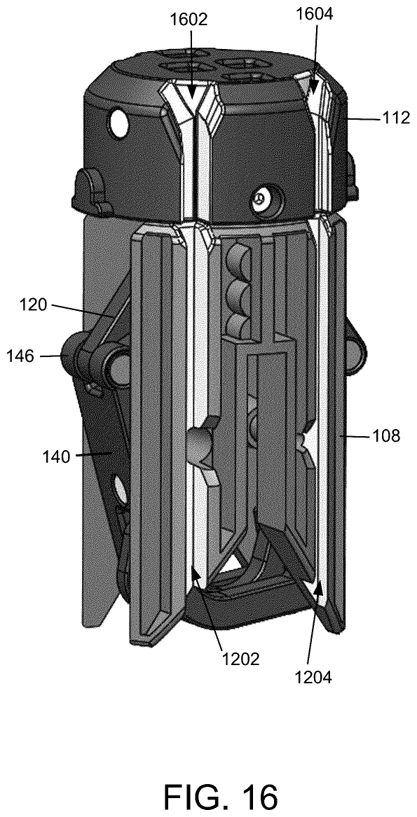

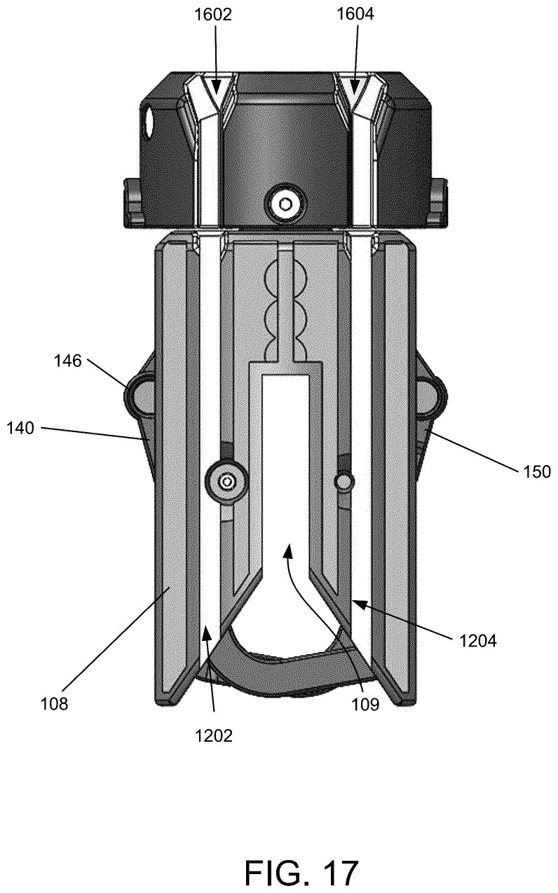

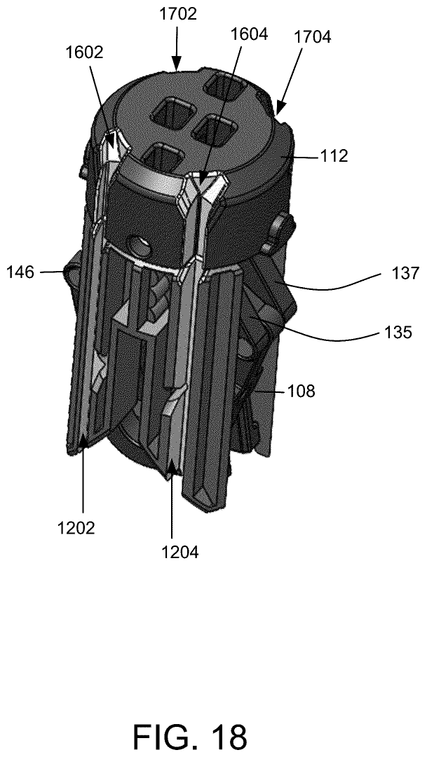

In some implementations, the second member 112 can include one or more channels that are substantially aligned with (e.g., can have coaxial centerlines with) the one or more elongate channels (e.g., channels 1202, 1204, 1206 or 1208) of the first member 108. Said differently, the one or more channels of the second member 112 and the one or more channels of the first member 108 can each be disposed such that they result in one or more channels that are approximately continuous and span a collective elongate length of the first member 108 and the second member 112. For example, as shown in FIGS. 16-18, the second member 112 can include the channels 1602, 1604, 1702, and 1704, which are disposed on the second member 112 such that at least one channel of the second member (e.g., channel 1602) is substantially aligned with the channel 1202 of the first member 108. In some implementations, the second member 112 can include a channel for each channel from the one or more channels of the first member 108, such that each channel of the second member 112 is substantially aligned with the respective channel of the first member 108 (e.g., channel 1602 can be substantially aligned with channel 1202, channel 1604 can be substantially aligned with 1204, channel 1702 can be substantially aligned with a channel not shown, but similar to and diagonally opposite channel 1204, and channel 1704 can be substantially aligned with a channel, not shown, but similar to and diagonally opposite channel 1202). Similarly, because the grasper is rotatable with respect to the second member 112, channel 1702 can be substantially aligned with channel 1204, channel 1704 can be substantially aligned with channel 1202, and channels 1602 and 1604 can be respectively substantially aligned with the channels diagonally opposite to channels 1202 and 1204, respectively.

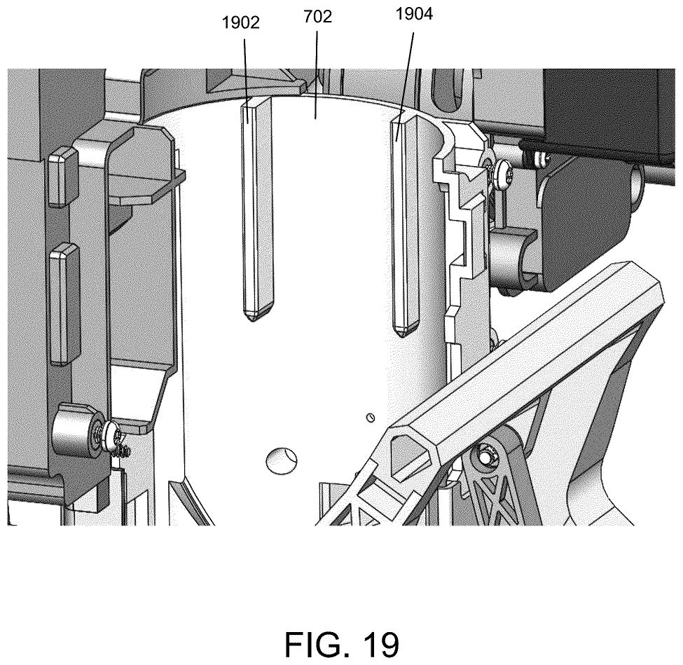

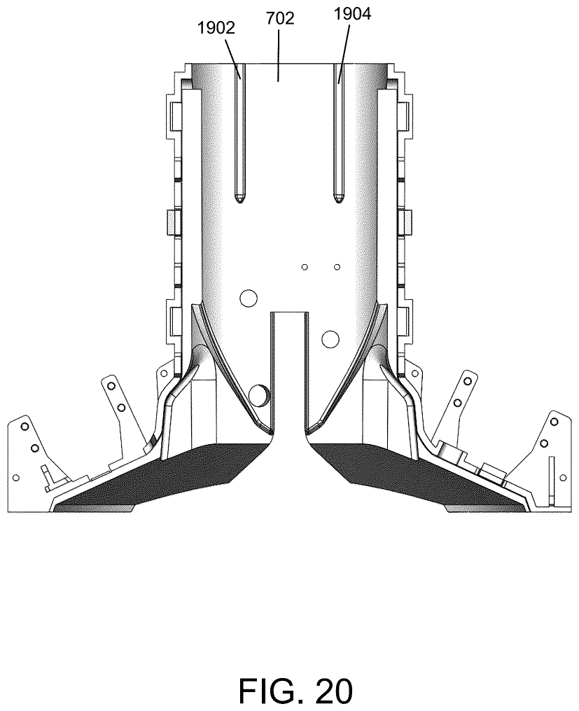

As shown in FIGS. 19 and 20, the receptacle 702 can include one or more extrusions and/or protrusions (e.g., a guide protrusion 1902, 1904) that is/are configured to be at least partially disposed within the elongate channels of the first member 108 and/or the channels of the second member 112 when the grasper 102 is in the predefined alignment. The one or more channels of the first member 108 and/or the second member 112 can be configured to substantially maintain the predefined alignment of the grasper 102 while at least a portion of receptacle (e.g., the guide protrusions 1902, 1904) are at least partially received within the one or more channels. In some implementations, the receptacle 702 can include an extrusion and/or protrusion for each of the elongate channels disposed on the first member 108 and/or the second member 112. For example, at least a portion of guide protrusion 1902 can be configured to be received by channel 1602 and/or 1202, and at least a portion of guide protrusion 1904 can be configured to be received by channels 1604 and/or 1204. The elongate channels can be configured to allow the grasper 102 to be raised and/or lowered (e.g., via the winch paying out and/or retrieving the tether 104) while being substantially maintained in the predefined alignment.

In an embodiment, an apparatus includes a receptacle configured to be coupled to an aerial vehicle, a winch configured to be coupled to the receptacle and the aerial vehicle, and a grasper having a multi-bar linkage. The grasper is configured to be coupled to the winch by a tether. The multi-bar linkage of the grasper is configured to be releasably coupled to a package. The grasper is configured to be rotated to a predefined alignment as the winch raises the grasper and the grasper contacts the receptacle.

In some implementations, the multi-bar linkage includes a link that is configured to interface the package and includes a magnet, and the receptacle includes a magnet positioned to magnetically couple to or magnetically repel the magnet of the link to rotate the grasper into the predefined alignment.

In some implementations, the grasper can include a first magnet and a second magnet. The receptacle can include a first magnet and a second magnet. The first magnet of the grasper and the first magnet of the receptacle can each be configured to repel the other, and the second magnet of the grasper and the second magnet of the receptacle can each be configured to attract the other.

In some implementations, the grasper can include a first portion and a second portion. The first portion of the grasper can be disposed on a first side of the package when coupled to the package and the second portion of the grasper can be disposed on a second side of the package opposite the first side of the package when coupled to the package. The first portion of the grasper can include a first magnet and a second magnet, and the second portion of the grasper can include a first magnet and a second magnet. The receptacle can include a first magnet, a second magnet, a third magnet, and a fourth magnet. The first magnet of the first portion of the grasper and the first magnet of the receptacle can each be configured to repel the other. The first magnet of the second portion of the grasper and the second magnet of the receptacle can each be configured to repel the other. The second magnet of the first portion of the grasper and the third magnet of the receptacle can each be configured to attract the other. The second magnet of the second portion of the grasper and the fourth magnet of the receptacle can each be configured to attract the other.

In some implementations, the receptacle can have a guide portion configured to rotate the grasper towards the predefined alignment as the winch raises the grasper and the grasper contacts the guide portion of the receptacle. In some implementations, the receptacle has a guide portion configured to rotate the grasper towards the predefined alignment as the winch raises the grasper and an outer surface of the grasper contacts the guide portion of the receptacle. The guide portion of the receptacle can narrow from a first location of the receptacle to a second location of the receptacle above the first location.

In some implementations, the grasper can be rotatable in a first direction and a second direction opposite the first direction. During use, the grasper can rotate in the first direction to the predefined alignment as the winch raises the grasper and the grasper contacts the receptacle during a first time period, and the grasper can rotate in the second direction to the predefined alignment as the winch raises the grasper and the grasper contacts the receptacle during a second time period mutually exclusive from the first time period.

In an embodiment, an apparatus includes a receptacle configured to be coupled to an aerial vehicle and including a magnet, a winch configured to be coupled to the receptacle and the aerial vehicle, and a grasper. The grasper is configured to be coupled to the winch by a tether, configured to be releasably coupled to a package, and includes a magnet. The grasper can be configured to be rotated to a predefined alignment as the winch raises the grasper and the grasper contacts the receptacle, and the magnet of the receptacle can be positioned to magnetically couple to or magnetically repel the magnet of the grasper to rotate the grasper into the predefined alignment.

In some implementations, the magnet of the grasper can be a first magnet, the grasper can include a second magnet. The magnet of the receptacle can be a first magnet, the receptacle can include a second magnet. The first magnet of the grasper and the first magnet of the receptacle can each be configured to repel the other, and the second magnet of the grasper and the second magnet of the receptacle can each be configured to attract the other.

In some implementations, the grasper can have a first portion and a second portion. The first portion of the grasper can be disposed on a first side of the package when coupled to the package, and the second portion of the grasper can be disposed on a second side of the package opposite the first side of the package when coupled to the package. The magnet of the grasper can be a first magnet and can be included in the first portion of the grasper. The first portion of the grasper can include a second magnet, and the second portion of the grasper can include a first magnet and a second magnet. The magnet of the receptacle can be a first magnet, and the receptacle can have a second magnet, a third magnet, and a fourth magnet. The first magnet of the first portion of the grasper and the first magnet of the receptacle can each be configured to repel the other. The first magnet of the second portion of the grasper and the second magnet of the receptacle can each be configured to repel the other. The second magnet of the first portion of the grasper and the third magnet of the receptacle can each be configured to attract the other. The second magnet of the second portion of the grasper and the fourth magnet of the receptacle can each be configured to attract the other.

In some implementations, the receptacle can have a guide portion configured to rotate the grasper towards the predefined alignment as the winch raises the grasper and the grasper contacts the guide portion of the receptacle. In some implementations, the receptacle can have a guide portion configured to rotate the grasper towards the predefined alignment as the winch raises the grasper and an outer surface of the grasper contacts the guide portion of the receptacle. The guide portion of the receptacle can narrow from a first location of the receptacle to a second of the receptacle above the first location.

In some implementations, the grasper can be rotatable in a first direction and a second direction opposite the first direction. During use, the magnet of the receptacle magnetically can repel the magnet of the grasper in one of the first direction or the second direction toward the predefined alignment before the grasper contacts the receptacle.

In an embodiment, a method includes releasing a package from a grasper of an aerial vehicle that has a winch and a tether that moveably couples the grasper to the aerial vehicle. The method also includes raising, after the releasing, the grasper into a receptacle coupled to the aerial vehicle. The method includes rotating the grasper into a predefined alignment within the receptacle as the grasper moves through a range of motion that includes a first position at an initial contact with the receptacle and a second position within the receptacle after the first position.

In some implementations, the rotating can include magnetically coupling or magnetically repelling a magnet of a link of the grasper and a magnet of the receptacle, the link included within a multi-bar linkage of the grasper. In some implementations, the grasper can include a first magnet and a second magnet, and the receptacle can include a first magnet and a second magnet. The rotating can include (1) magnetically repelling the first magnet of the grasper and the first magnet of the receptacle from each other, and (2) magnetically attracting the second magnet of the grasper and the second magnet of the receptacle to each other.

In some implementations, the grasper can have a first portion and a second portion. The first portion of the grasper can be disposed on a first side of the package when coupled to the package, and the second portion of the grasper can be disposed on a second side of the package opposite the first side of the package when the coupled to the package. The first portion of the grasper can include a first magnet and a second magnet, and the second portion of the grasper can include a first magnet and a second magnet. The receptacle can include a first magnet, a second magnet, a third magnet and a fourth magnet. The rotating can include (1) magnetically repelling first magnet of the first portion of the grasper and the first magnet of the receptacle from each the other, (2) magnetically repelling the first magnet of the second portion of the grasper and the second magnet of the receptacle from each other, (3) magnetically attracting the second magnet of the first portion of the grasper and the third magnet of the receptacle to each other, and (4) magnetically attracting the second magnet of the second portion of the grasper and the fourth magnet of the receptacle to each other.

In some implementations, the rotating can include rotating the grasper towards the predefined alignment as the winch raises the grasper and the grasper contacts a guide portion of the receptacle. In some implementations, the rotating can include rotating the grasper towards the predefined alignment as the winch raises the grasper and the grasper contacts a guide portion of the receptacle. The guide portion of the receptacle can narrow from a first location of the receptacle to a second of the receptacle above the first location. In some implementations, the rotating includes rotating the grasper in a first direction to the predefined alignment as the winch raises the grasper and the grasper contacts the receptacle during a first time period. The method can also include rotating the grasper in a second direction opposite to the first direction to the predefined alignment as the winch raises the grasper and the grasper contacts the receptacle during a second time period mutually exclusive from the first time period.

### Load Cell and Guide Pulley

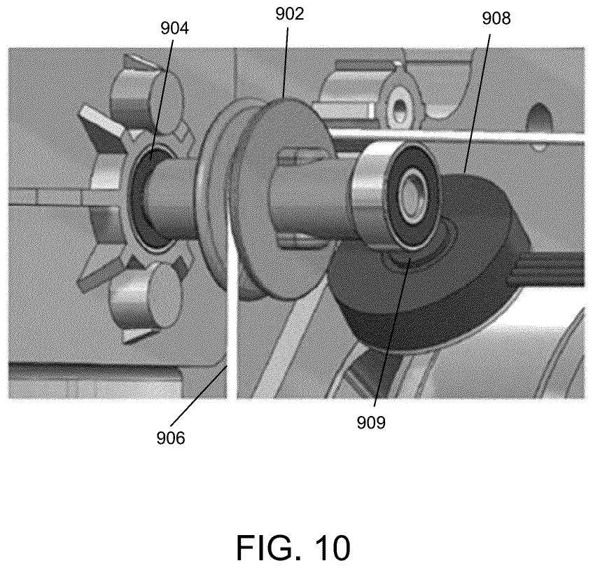

FIG. 10 shows a portion of an apparatus according to an embodiment that includes a load cell 908, a rotation encoder 904, and a guide pulley 902 configured to interact with a tether 906. The tether 906 can be similar or identical to any tether described herein, for example, tether 104. A first end of tether 906 can be coupled to a grasper (not shown in FIG. 10; e.g., grasper 102), and a second end of tether 906 can be configured to interact with a winch (not shown in FIG. 10). The winch can be similar or identical to any winch described herein, such as winch 600, and can be configured to be coupled to and for use with a drone or aerial vehicle, or other vehicle described herein to pick up, transport, and deliver packages. The winch can be configured to pull in, wind up, pay out, let out, wind out, and/or otherwise adjust the tension of tether 906. The guide pulley 902 is disposed to interact with an intermediate portion of tether 906 between the first end of tether and second end of tether. In some implementations, the guide pulley 902 includes a substantially annular guide disk that defines a guide channel on a sidewall of the guide disk. The guide disk can be configured such that at least a portion of the tether 906 can be disposed, at least partially, within the guide channel and in contact with the guide disk. At least a portion of the surface of the guide disk defining the guide channel is configured to have sufficiently high surface friction such that at least a portion of guide pulley 902 rotates in response to the winch pulling in and/or paying out tether 906. Said differently, a portion of guide pulley 902 can remain in contact with a portion of tether 906 while the portion of guide pulley 902 rotates a non-zero angle.

Guide pulley 902, tether 906, and the winch can be configured such that tether 906 is disposed around a portion of guide pulley 902. In some implementations, a first portion of tether 906 disposed between the grasper (e.g., grasper 102 of FIG. 1) and guide pulley 902 is substantially orthogonal to a second portion of tether 906 disposed between guide pulley 902 and the winch (e.g., winch 600 of FIG. 6). Said differently, tether 906 can have an approximately 90-degree turn around a portion of the circumference of the guide disk of guide pulley 902. In some implementations, an angle between (1) the first portion of tether 906 disposed between the grasper and the guide pulley 902 and (2) the second portion of tether 906 disposed between guide pulley 902 and the winch is less than, equal to, or greater than about 90-degrees.

The load cell 908 is configured to generate one or more electrical signals based, at least in part, on one or more forces applied to load cell 908. In some implementations, load cell 908 includes one or more strain gauges configured to produce one or more electrical signals in response to guide pulley 902 applying one or more forces to load cell 908. In some implementations, load cell 908 includes a pneumatic, hydraulic, vibrating, or piezoelectric load cell. One or more processors can be configured to use the one or more electrical signals to generate one or more values corresponding to (or based on, or indicative of) the one or more forces. For example, one or more processors can be configured to use the one or more electrical signals generated using load cell 908 to generate a value corresponding to (1) the weight of the package releasably coupled to the grasper and/or (2) line tension within tether 906.

In some implementations, the load cell 908 is configured to generate an electrical signal based on a force applied in a direction substantially normal to a sensing surface 909 of load cell 908. As a result of tether 906 having a first portion that is substantially parallel to a reference plane and a second portion that is substantially perpendicular to the reference plane, the guide pulley 902 configured to interact with tether 906 can apply a force to load cell 908, the force having a non-zero vertical component and a non-zero horizontal component relative to the reference plane. Load cell 908 can be disposed proximate to at least a portion of guide pulley 902 (e.g., a distal end portion of the guide pulley 902 nearly touching the sensing surface 909 of the load cell 908 when no tension is present on tether 906) such that guide pulley 902 can apply a force to load cell 908 as a result of a force (e.g., package weight) being applied to tether 906. The load cell 908 can have an orientation configured such that the sensing surface 909 of load cell 908 proximal to the portion of guide pulley 902 that applies a force to load cell 908 is substantially parallel to an axis of rotation of guide pulley 902 and substantially angled relative to both (1) a first reference plane substantially parallel to a first portion of tether 906 disposed between the grasper and guide pulley 902 and (2) a second reference plane substantially parallel to a second portion of tether 906 disposed between guide pulley 902 and the winch. In some implementations, the sensing surface of load cell 908 is oriented at an approximately 45-degree angle relative to at least one of or both the first reference plane and the second reference plane. The first and second reference planes can be substantially orthogonal to each other. In some implementations, the sensing surface 909 of load cell 908 is oriented such that the angle between the sensing surface and the first reference plane and the angle between the sensing surface and the second reference plane are substantially the same magnitude. In some implementations, load cell 908 can be oriented such that guide pulley 902 applies a force to load cell 908 that is substantially normal to the sensing surface of load cell 908 when a package is releasably coupled, at least indirectly, to the tether 906 and is disposed in a substantially vertical alignment with at least a portion of the guide pulley. In this manner, the load cell 908 can be oriented such that a friction force between load cell 908 and guide pulley 902 is substantially reduced or eliminated.

In some implementations, a first end (also referred to as proximal end) of the guide pulley 902 substantially opposite a second end (also referred to as distal end) of guide pulley 902 proximate to load cell 908 is coupled to the rotation encoder 904. Rotation encoder 904 is configured to generate one or more electrical signals based on a rotational displacement of rotation encoder 904. As a result of rotation encoder 904 being coupled to the guide pulley 902 that is configured to interact with tether 906, the rotation encoder 904 can be used to measure, based, at least in part, on a diameter of guide pulley 902, an amount of tether 906 that the winch pays out and/or retrieves and/or the speed at which the winch pays out and/or retrieves tether 906. The rotation encoder 904 can be or include a conductive encoder, an optical encoder, a magnetic encoder, or any other encoder suitable for use as a rotary encoder. The rotational encoder 904 can include an absolute encoder and/or an incremental encoder.

In some implementations, the guide pulley 902 can deflect a non-zero distance as a result of a force applied to guide pulley 902. In some implementations, guide pulley 902 is substantially rigid, and a flexible mount (e.g., a bushing) is disposed between guide pulley 902 and encoder 904 and configured to deform as a result of a force applied to the flexible mount. The flexible mount can comprise rubber or any other elastic material suitable for a flexible mount. As a result of the deformation of the flexible mount, an end of guide pulley 902 proximal to a sensing surface of load cell 908 can move towards the sensing surface of load cell 908 as a result of one or more forces applied to guide pulley 902 (e.g., package weight and/or a force applied by the winch). The flexible mount can be configured to move guide pulley 902 away from a sensing surface of load cell 908 when a force is no longer applied to guide pulley 902. For example, guide pulley 902 can move out of contact with load cell 908 if a package (e.g., package 106 of FIG. 1) is removed from the grasper coupled to tether 906.

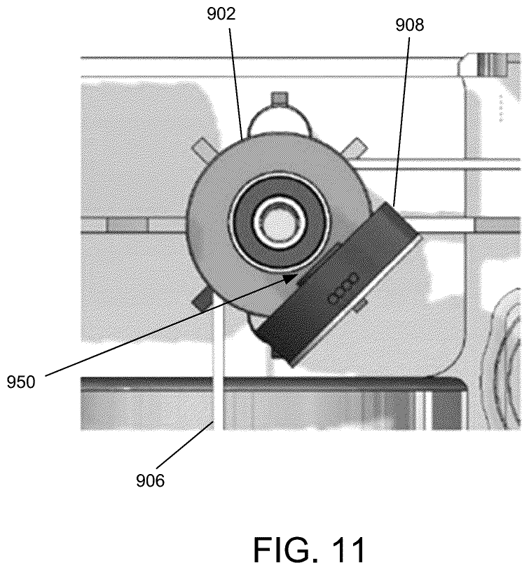

FIG. 11 shows guide pulley 902 separated from load cell 908 by air gap 950 and configured to interact with tether 906, according to an embodiment. Air gap 950 can comprise a variable separation distance between guide pulley 902 and load cell 908. Air gap 950 (i.e., the separation distance) can be larger when the grasper (e.g., grasper 102) is not releasably coupled to a package (e.g., package 106) than when the grasper is coupled to a package. Guide pulley 902 can be configured to pivot and/or translate such that guide pulley 902 moves through air gap 950 to contact load cell 908 in response to one or more forces applied to guide pulley 902. Load cell 908 can be oriented such that the motion of guide pulley 902 through air gap 950 follows a trajectory that is substantially normal to a sensing surface of load cell 908 when the tether 906 is used to suspend a package above a landing surface and the package is disposed in a substantially vertical alignment with at least a portion of the guide pulley. In some implementations, a surface of guide pulley 902 and a surface of load cell 908 are configured to be a distance away from each other to result in an air gap 950 being disposed between the surface of guide pulley 902 and the surface of load cell 908. The guide pulley 902 and the load cell 908 are configured such that a package having a minimum weight and/or a force applied by the winch (e.g., winch 600) causes the movement of guide pulley 902 to overcome air gap 950 and contact load cell 908. The guide pulley 902 can be configured to pivot and/or translate away from load cell 908 as a result of, for example, a package being decoupled from the grasper, slackening of the tether 906 (e.g., as a result of a package coupled to the grasper contacting a landing surface), or the winch paying out tether 906. As a result of a reduction in a force applied to guide pulley 902, guide pulley can pivot and/or translate away from load cell 908, by way of deformation of the flexible mount, resulting in air gap 950 disposed between a surface of guide pulley 902 and a surface of load cell 908.

In some implementations, at least some of the apparatus described above with respect to FIGS. 1-11 can be configured for package pick-up and delivery by a ground vehicle. Examples of a ground vehicle can include a car, a truck, a rover, a wheeled robot, or any other ground vehicle suitable for package delivery. For example, the tether 104 can be movably coupled to an arm, crane, pole, tower, or other elongate structure coupled to the ground vehicle, such that at least a portion of the tether 104 is suspended above the ground from the ground vehicle. A first end of the tether 104 can be coupled to a winch, crank, pulley, or any other device configured to pay out and retrieve the tether 104. The grasper 102 can be coupled to a second end of the tether 104 substantially opposite the first end. The grasper 102 is configured to be releasably coupled to a package. In some implementations, the tether 104 is disposed such that at least a portion of the tether 104 is not vertically aligned with any portion of the ground vehicle below the tether 104, allowing the grasper 102 to be lowered and releasably coupled to a package in contact with the ground or other landing surface and/or to be lowered to release the package to the ground or other landing surface.

In some implementations, at least some of the apparatus described above with respect to FIGS. 1-11 can be configured for package pick-up and delivery by a water vehicle. Examples of a water vehicle can include a barge, a boat, a raft, or any other water vehicle suitable for package delivery. The tether 104 can be movably coupled to an arm, crane, pole, tower, or other elongate structure coupled to the water vehicle, such that at least a portion of the tether 104 is suspended above the water from the water vehicle. A first end of the tether 104 can be coupled to any device that is coupled to the water vehicle and configured to pay out and retrieve the tether 104. Examples of said device can include a winch, a crank, or a pulley, or any other device configured to pay out and retrieve the tether 104. The grasper 102 can be coupled to a second end of the tether 104 substantially opposite the first end. The grasper 102 is configured to be releasably coupled to a package. In some implementations, the tether 104 is disposed such that at least a portion of the tether 104 is not vertically aligned with any portion of the water vehicle below the tether 104, allowing the grasper 102 to be lowered and releasably coupled to a package that is in contact with a landing surface (e.g., dock, barge, or other platform on the surface of the water or a landing surface adjacent to the water, such as a landing surface on the shore), and/or to be lowered to release the package to the landing surface.

All combinations of the foregoing concepts and additional concepts discussed here (provided such concepts are not mutually inconsistent) are contemplated as being part of the subject matter disclosed herein. The terminology explicitly employed herein that also may appear in any disclosure incorporated by reference should be accorded a meaning most consistent with the particular concepts disclosed herein.

The skilled artisan will understand that the drawings primarily are for illustrative purposes, and are not intended to limit the scope of the subject matter described herein. The drawings are not necessarily to scale; in some instances, various aspects of the subject matter disclosed herein may be shown exaggerated or enlarged in the drawings to facilitate an understanding of different features. In the drawings, like reference characters generally refer to like features (e.g., functionally similar and/or structurally similar elements).

To address various issues and advance the art, the entirety of this application (including the Cover Page, Title, Headings, Background, Summary, Brief Description of the Drawings, Detailed Description, Embodiments, Abstract, Figures, Appendices, and otherwise) shows, by way of illustration, various embodiments in which the embodiments may be practiced. The advantages and features of the application are of a representative sample of embodiments only, and are not exhaustive and/or exclusive. Rather, they are presented to assist in understanding and teach the embodiments, and are not representative of all embodiments. As such, certain aspects of the disclosure have not been discussed herein. That alternate embodiments may not have been presented for a specific portion of the innovations or that further undescribed alternate embodiments may be available for a portion is not to be considered to exclude such alternate embodiments from the scope of the disclosure. It will be appreciated that many of those undescribed embodiments incorporate the same principles of the innovations and others are equivalent. Thus, it is to be understood that other embodiments may be utilized and functional, logical, operational, organizational, structural and/or topological modifications may be made without departing from the scope and/or spirit of the disclosure. As such, all examples and/or embodiments are deemed to be non-limiting throughout this disclosure.

Also, no inference should be drawn regarding those embodiments discussed herein relative to those not discussed herein other than it is as such for purposes of reducing space and repetition. For instance, it is to be understood that the logical and/or topological structure of any combination of any program components (a component collection), other components and/or any present feature sets as described in the figures and/or throughout are not limited to a fixed operating order and/or arrangement, but rather, any disclosed order is exemplary and all equivalents, regardless of order, are contemplated by the disclosure.

Various concepts may be embodied as one or more methods, of which at least one example has been provided. The acts performed as part of the method may be ordered in any suitable way. Accordingly, embodiments may be constructed in which acts are performed in an order different than illustrated, which may include performing some acts simultaneously, even though shown as sequential acts in illustrative embodiments. Put differently, it is to be understood that such features may not necessarily be limited to a particular order of execution, but rather, any number of threads, processes, services, servers, and/or the like that may execute serially, asynchronously, concurrently, in parallel, simultaneously, synchronously, and/or the like in a manner consistent with the disclosure. As such, some of these features may be mutually contradictory, in that they cannot be simultaneously present in a single embodiment. Similarly, some features are applicable to one aspect of the innovations, and inapplicable to others.

In addition, the disclosure may include other innovations not presently described. Applicant reserves all rights in such innovations, including the right to embodiment such innovations, file additional applications, continuations, continuations-in-part, divisionals, and/or the like thereof. As such, it should be understood that advantages, embodiments, examples, functional, features, logical, operational, organizational, structural, topological, and/or other aspects of the disclosure are not to be considered limitations on the disclosure as defined by the embodiments or limitations on equivalents to the embodiments. Depending on the particular desires and/or characteristics of an individual and/or enterprise user, database configuration and/or relational model, data type, data transmission and/or network framework, syntax structure, and/or the like, various embodiments of the technology disclosed herein may be implemented in a manner that enables a great deal of flexibility and customization as described herein.

All definitions, as defined and used herein, should be understood to control over dictionary definitions, definitions in documents incorporated by reference, and/or ordinary meanings of the defined terms.

As used herein, in particular embodiments and unless stated otherwise, the terms “about” “substantially” or “approximately” when preceding a numerical value indicates the value plus or minus a range of 10%. Where a range of values is provided, it is understood that each intervening value, to the tenth of the unit of the lower limit unless the context clearly dictates otherwise, between the upper and lower limit of that range and any other stated or intervening value in that stated range is encompassed within the disclosure. That the upper and lower limits of these smaller ranges can independently be included in the smaller ranges is also encompassed within the disclosure, subject to any specifically excluded limit in the stated range. Where the stated range includes one or both of the limits, ranges excluding either or both of those included limits are also included in the disclosure.

The indefinite articles “a” and “an,” as used herein in the specification and in the embodiments, unless clearly indicated to the contrary, should be understood to mean “at least one.”

The phrase “and/or,” as used herein in the specification and in the embodiments, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

As used herein in the specification and in the embodiments, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the embodiments, “consisting of,” will refer to the inclusion of exactly one element of a number or list of elements. In general, the term “or” as used herein shall only be interpreted as indicating exclusive alternatives (i.e. “one or the other but not both”) when preceded by terms of exclusivity, such as “either,” “one of,” “only one of,” or “exactly one of.” “Consisting essentially of,” when used in the embodiments, shall have its ordinary meaning as used in the field of patent law.

As used herein in the specification and in the embodiments, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

In the embodiments, as well as in the specification above, all transitional phrases such as “comprising,” “including,” “carrying,” “having,” “containing,” “involving,” “holding,” “composed of,” and the like are to be understood to be open-ended, i.e., to mean including but not limited to. Only the transitional phrases “consisting of” and “consisting essentially of” shall be closed or semi-closed transitional phrases, respectively, as set forth in the United States Patent Office Manual of Patent Examining Procedures, Section 2111.03.

Some embodiments and/or methods described herein can be performed by software (executed on hardware), hardware, or a combination thereof. Hardware modules may include, for example, a processor, a field programmable gate array (FPGA), and/or an application specific integrated circuit (ASIC). Software modules (executed on hardware) can include instructions stored in a memory that is operably coupled to a processor, and can be expressed in a variety of software languages (e.g., computer code), including C, C++, Java™, Ruby, Visual Basic™, and/or other object-oriented, procedural, or other programming language and development tools. Examples of computer code include, but are not limited to, micro-code or micro-instructions, machine instructions, such as produced by a compiler, code used to produce a web service, and files containing higher-level instructions that are executed by a computer using an interpreter. For example, embodiments may be implemented using imperative programming languages (e.g., C, Fortran, etc.), functional programming languages (Haskell, Erlang, etc.), logical programming languages (e.g., Prolog), object-oriented programming languages (e.g., Java, C++, etc.) or other suitable programming languages and/or development tools. Additional examples of computer code include, but are not limited to, control signals, encrypted code, and compressed code.

The term “processor” should be interpreted broadly to encompass a general purpose processor, a central processing unit (CPU), a microprocessor, a digital signal processor (DSP), a controller, a microcontroller, a state machine and so forth. Under some circumstances, a “processor” may refer to an application specific integrated circuit (ASIC), a programmable logic device (PLD), a field programmable gate array (FPGA), etc. The term “processor” may refer to a combination of processing devices, e.g., a combination of a DSP and a microprocessor, a plurality of microprocessors, one or more microprocessors in conjunction with a DSP core or any other such configuration.

The term “memory” should be interpreted broadly to encompass any electronic component capable of storing electronic information. The term memory may refer to various types of processor-readable media such as random access memory (RAM), read-only memory (ROM), non-volatile random access memory (NVRAM), programmable read-only memory (PROM), erasable programmable read only memory (EPROM), electrically erasable PROM (EEPROM), flash memory, magnetic or optical data storage, registers, etc. Memory is said to be in electronic communication with a processor if the processor can read information from and/or write information to the memory. Memory that is integral to a processor is in electronic communication with the processor.

The terms “instructions” and “code” should be interpreted broadly to include any type of computer-readable statement(s). For example, the terms “instructions” and “code” may refer to one or more programs, routines, sub-routines, functions, procedures, etc. “Instructions” and “code” may comprise a single computer-readable statement or many computer-readable statements.

While specific embodiments of the present disclosure have been outlined above, many alternatives, modifications, and variations will be apparent to those skilled in the art. Accordingly, the embodiments set forth herein are intended to be illustrative, not limiting. Various changes may be made without departing from the spirit and scope of the disclosure.

What is claimed is:

1. An apparatus, comprising:
a receptacle configured to be coupled to an aerial vehicle;
a winch configured to be coupled to the receptacle and the aerial vehicle; and
a grasper having a multi-bar linkage, the grasper configured to be coupled to the winch by a tether, the multi-bar linkage of the grasper configured to be releasably coupled to a package,
the grasper configured to be rotated to a predefined alignment as the winch raises the grasper and the grasper contacts the receptacle.

2. The apparatus of claim 1, wherein:
the multi-bar linkage includes a link, the link is configured to interface the package and includes a magnet,
the receptacle includes a magnet positioned to magnetically couple to or magnetically repel the magnet of the link to rotate the grasper into the predefined alignment.

3. The apparatus of claim 1, wherein:
the grasper includes a first magnet and a second magnet,
the receptacle includes a first magnet and a second magnet,
the first magnet of the grasper and the first magnet of the receptacle each configured to repel the other,
the second magnet of the grasper and the second magnet of the receptacle each configured to attract the other.

4. The apparatus of claim 1, wherein:
the grasper includes a first portion and a second portion,
the first portion of the grasper is disposed on a first side of the package when coupled to the package, the second portion of the grasper is disposed on a second side of the package opposite the first side of the package when the coupled to the package,
the first portion of the grasper includes a first magnet and a second magnet, the second portion of the grasper includes a first magnet and a second magnet,
the receptacle includes a first magnet, a second magnet, a third magnet and a fourth magnet,
the first magnet of the first portion of the grasper and the first magnet of the receptacle each configured to repel the other,
the first magnet of the second portion of the grasper and the second magnet of the receptacle each configured to repel the other,
the second magnet of the first portion of the grasper and the third magnet of the receptacle each configured to attract the other,
the second magnet of the second portion of the grasper and the fourth magnet of the receptacle each configured to attract the other.

5. The apparatus of claim 1, wherein:
the receptacle has a guide portion configured to rotate the grasper towards the predefined alignment as the winch raises the grasper and the grasper contacts the guide portion of the receptacle.

6. The apparatus of claim 1, wherein:
the receptacle has a guide portion configured to rotate the grasper towards the predefined alignment as the winch raises the grasper and an outer surface of the grasper contacts the guide portion of the receptacle,
the guide portion of the receptacle narrows from a first location of the receptacle to a second location of the receptacle above the first location.

7. The apparatus of claim 1, wherein:
the grasper is rotatable in a first direction and a second direction opposite the first direction,
during use, the grasper rotates in the first direction to the predefined alignment as the winch raises the grasper and the grasper contacts the receptacle during a first time period, and the grasper rotates in the second direction to the predefined alignment as the winch raises the grasper and the grasper contacts the receptacle during a second time period mutually exclusive from the first time period.

8. An apparatus, comprising:
a receptacle configured to be coupled to an aerial vehicle and including a magnet;
a winch configured to be coupled to the receptacle and the aerial vehicle; and
a grasper configured to be coupled to the winch by a tether, the grasper configured to be releasably coupled to a package and including a magnet,
the grasper configured to be rotated to a predefined alignment as the winch raises the grasper and the grasper contacts the receptacle,
the magnet of the receptacle positioned to magnetically couple to or magnetically repel the magnet of the grasper to rotate the grasper into the predefined alignment.

9. The apparatus of claim 8, wherein:
the magnet of the grasper is a first magnet, the grasper includes a second magnet,
the magnet of the receptacle is a first magnet, the receptacle includes a second magnet,
the first magnet of the grasper and the first magnet of the receptacle each configured to repel the other,
the second magnet of the grasper and the second magnet of the receptacle each configured to attract the other.

10. The apparatus of claim 8, wherein:
the grasper has a first portion and a second portion,
the first portion of the grasper is disposed on a first side of the package when coupled to the package, the second portion of the grasper disposed on a second side of the package opposite the first side of the package when the coupled to the package,
the magnet of the grasper is a first magnet and is included in the first portion of the grasper, the first portion of the grasper includes a second magnet, the second portion of the grasper includes a first magnet and a second magnet,
the magnet of the receptacle is a first magnet, the receptacle has a second magnet, a third magnet and a fourth magnet,
the first magnet of the first portion of the grasper and the first magnet of the receptacle each configured to repel the other,
the first magnet of the second portion of the grasper and the second magnet of the receptacle each configured to repel the other,
the second magnet of the first portion of the grasper and the third magnet of the receptacle each configured to attract the other,
the second magnet of the second portion of the grasper and the fourth magnet of the receptacle each configured to attract the other.

11. The apparatus of claim 8, wherein:
the receptacle has a guide portion configured to rotate the grasper towards the predefined alignment as the winch raises the grasper and the grasper contacts the guide portion of the receptacle.

12. The apparatus of claim 8, wherein:
the receptacle has a guide portion configured to rotate the grasper towards the predefined alignment as the winch raises the grasper and an outer surface of the grasper contacts the guide portion of the receptacle,
the guide portion of the receptacle narrows from a first location of the receptacle to a second of the receptacle above the first location.

13. The apparatus of claim 8, wherein:
the grasper is rotatable in a first direction and a second direction opposite the first direction,
during use, the magnet of the receptacle magnetically repels the magnet of the grasper in one of the first direction or the second direction toward the predefined alignment before the grasper contacts the receptacle.

14. A method, comprising:
releasing a package from a grasper of an aerial vehicle that has a winch and a tether that moveably couples the grasper to the aerial vehicle;
raising, after the releasing, the grasper into a receptacle coupled to the aerial vehicle; and
rotating the grasper into a predefined alignment within the receptacle as the grasper moves through a range of motion that includes a first position at an initial contact with the receptacle and a second position within the receptacle after the first position.

15. The method of claim 14, wherein:
the rotating includes magnetically coupling or magnetically repelling a magnet of a link of the grasper and a magnet of the receptacle, the link included within a multi-bar linkage of the grasper.

16. The method of claim 14, wherein:
the grasper includes a first magnet and a second magnet,
the receptacle includes a first magnet and a second magnet,
the rotating includes (1) magnetically repelling the first magnet of the grasper and the first magnet of the receptacle from each other, and (2) magnetically attracting the second magnet of the grasper and the second magnet of the receptacle to each other.

17. The method of claim 14, wherein:
the grasper has a first portion and a second portion, the first portion of the grasper is disposed on a first side of the package when coupled to the package, the second portion of the grasper is disposed on a second side of the package opposite the first side of the package when the coupled to the package,
the first portion of the grasper includes a first magnet and a second magnet, the second portion of the grasper includes a first magnet and a second magnet,
the receptacle includes a first magnet, a second magnet, a third magnet and a fourth magnet,
the rotating includes (1) magnetically repelling first magnet of the first portion of the grasper and the first magnet of the receptacle from each the other, (2) magnetically repelling the first magnet of the second portion of the grasper and the second magnet of the receptacle from each other, (3) magnetically attracting the second magnet of the first portion of the grasper and the third magnet of the receptacle to each other, and (4) magnetically attracting the second magnet of the second portion of the grasper and the fourth magnet of the receptacle to each other.

18. The method of claim 14, wherein:
the rotating includes rotating the grasper towards the predefined alignment as the winch raises the grasper and the grasper contacts a guide portion of the receptacle.

19. The method of claim 14, wherein:
the rotating includes rotating the grasper towards the predefined alignment as the winch raises the grasper and the grasper contacts a guide portion of the receptacle,
the guide portion of the receptacle narrows from a first location of the receptacle to a second of the receptacle above the first location.

20. The method of claim 14, wherein:
the rotating includes rotating the grasper in a first direction to the predefined alignment as the winch raises the grasper and the grasper contacts the receptacle during a first time period,
the method further comprising:
rotating the grasper in a second direction opposite to the first direction to the predefined alignment as the winch raises the grasper and the grasper contacts the receptacle during a second time period mutually exclusive from the first time period.
